(19) United States
(12) Patent Application Publication
(10) Pub. No.: US 2026/0368234 A1
(43) Pub. Date: Nov. 19, 2026

(54) SYSTEM AND METHOD FOR PROGRESSIVE CUMULATIVE PERPLEXITY MEASUREMENT

(71) Applicant: ACTIMIZE LTD, Ra'anana (IL)

(72) Inventors: Elina MALIARSKY, Hod Ha Sharon (IL); Danny BUTVINIK, Haifa (IL)

(21) Appl. No.: 19/209,008

(22) Filed: May 15, 2025

(51) Int. Cl. G06F 16/34; G06Q 20/40

(52) U.S. Cl. CPC G06F 16/345; G06Q 20/4016

(57) ABSTRACT

A real-time system detects and corrects inconsistencies in machine-generated text. The system includes a fraud management configured to perform operations which include: receiving suspicious financial data from a database; with a prompt generation service, based on the suspicious financial data, generating a prompt; and transmitting the suspicious financial data and the prompt to a summary service. The operations also include, in real time, receiving from the summary service a summary of the suspicious financial data, where the summary includes natural language in a sentence-by-sentence format. The operations also include, with a summary evaluation service, for each sentence of the summary: calculating a cumulative perplexity of the sentence and at least one previous sentence; calculating a cumulative perplexity difference between the cumulative perplexity and a previous value of the cumulative perplexity; and if the cumulative perplexity or the cumulative perplexity difference exceeds a threshold value, triggering an automated action.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The subject matter described herein relates to systems, devices, and methods for measuring the perplexity of machine-generated text. This cumulative perplexity measurement system has particular but not exclusive utility for determining the quality and usefulness of text generated by a large language model (LLM).

### BACKGROUND

Machine learning (ML), deep learning (DL), and artificial intelligence (AI) techniques, including large language models (LLMs), are used for financial crime detection, for example in Anti-Money Laundering (AML) and fraud detection. Existing AI solutions within financial institutions are typically designed for general-purpose tasks, lacking the specialized capability to assess and refine the consistency and coherence of AI-generated content in the highly specialized domain of financial crime investigation.

Deep Learning (DL), a subset of ML, utilizes neural networks with many layers to process large volumes of data and extract complex features. DL has revolutionized financial crime detection by automating the generation of reports, analyzing large datasets, and performing sophisticated tasks like fraud prediction.

Natural Language Processing (NLP) is a subfield of AI dedicated to enabling machines to understand, interpret, and generate human language. In financial crime detection, NLP is used to analyze financial documents, such as transaction reports, regulatory filings, and investigative summaries. These documents often contain complex terminology and context-dependent language that requires specialized models capable of understanding domain-specific vocabulary and nuances.

LLMs, a key application of DL, have shown promise in generating human-like text, such as financial summaries and case reports. However, one challenge of DL models is maintaining coherence and consistency over long texts, particularly in complex financial reports. This is critical in financial crime detection, where reports must remain clear and logically structured to facilitate investigations.

Accordingly, long-felt needs exist for improved LLM text generation to address the forgoing and other concerns.

The information included in this Background section of the specification, including any references cited herein and any description or discussion thereof, is included for technical reference purposes only and is not to be regarded as subject matter by which the scope of the disclosure is to be bound.

### SUMMARY

Disclosed is a cumulative perplexity measurement system that addresses the deficiencies in LLM text generation by introducing a novel approach based on cumulative perplexity metrics, leveraging AI methods to improve the clarity, reliability, and utility of LLM outputs. The objective is to enhance AI systems' ability to process, summarize, and analyze complex financial narratives in real-time, ensuring that the generated content remains contextually accurate and aligned with, e.g., financial crime detection goals. The cumulative perplexity measurement system disclosed herein has particular, but not exclusive, utility for improving, in real time, the text generated by an LLM.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a real-time system for detecting and correcting inconsistencies in machine-generated text. The real-time system includes a fraud management server having at least one processor and a computer readable medium operably coupled thereto, the server being in electronic communication with a summary service, the server being configured to send suspicious financial data to the summary service and receive a summary of the suspicious financial data from the summary service, the processor including a summary evaluation service and a prompt generation service, the server being in electronic communication with a database for storing the suspicious financial data, the computer readable medium including a plurality of instructions stored in association therewith that are accessible to, and executable by, the processor, to perform operations. The operations may include: receiving the suspicious financial data from the database; with the prompt generation service, based on the suspicious financial data, generating a prompt; transmitting the suspicious financial data and the prompt to the summary service; in real time, receiving from the summary service a summary of the suspicious financial data, where the summary may include natural language in a sentence-by-sentence format; and with the summary evaluation service, for each sentence of the summary: calculating a cumulative perplexity of the sentence and at least one previous sentence; calculating a cumulative perplexity difference between the cumulative perplexity and a previous value of the cumulative perplexity; and if the cumulative perplexity or the cumulative perplexity difference exceeds a threshold value, triggering an automated action. Other embodiments of this aspect include corresponding computer systems, apparatus, and computer programs recorded on one or more computer storage devices, each configured to perform the actions of the methods.

Implementations may include one or more of the following features. In some embodiments, the automated action may include, based on the suspicious financial data, the prompt, and the cumulative perplexity or the cumulative perplexity difference: with the prompt generation service, revising the prompt; and sending the revised prompt to the summary service. In some embodiments, the automated action may include instructing the summary service to: correct the sentence or a previous sentence; and continue generating the summary. In some embodiments, calculating the cumulative perplexity of the sentence and at least one previous sentence involves calculating a cumulative perplexity of the sentence and all previous sentences. In some embodiments, calculating the cumulative perplexity difference between the cumulative perplexity and a previous value of the cumulative perplexity involves calculating a cumulative perplexity difference between the cumulative perplexity and a most recent previous value of the cumulative perplexity. In some embodiments, the operations further may include: displaying, to a user, a graph of the cumulative perplexity over time; and updating the graph each time a new sentence is received. In some embodiments, the operations further may include: displaying, to a user, a graph of the cumulative perplexity difference over time; and updating the graph each time a new sentence is received. In some embodiments, the suspicious financial data may include structured information may include at least one of: a financial document, a transaction report, a transaction record, a transaction history, a regulatory filing, a regulatory update, a fraud pattern, an investigative summary, a financial dataset, or a customer profile. In some embodiments, the suspicious financial data may include unstructured information may include at least one of: a customer communication, a legal document, a regulatory guideline, a geopolitical risk factor, or a description of legal implications. In some embodiments, the summary may include a suspicious transaction report, a fraud investigation report, an insider trading investigation report, or an anti-money-laundering investigation report. Implementations of the described techniques may include hardware, a method or process, or computer software on a computer-accessible medium.

One general aspect includes a computer-implemented method for detecting and correcting inconsistencies in real-time in machine-generated text. The computer-implemented method includes, with a fraud management server having at least one processor and a computer readable medium operably coupled thereto, the server being in electronic communication with a summary service, the server being configured to send suspicious financial data to the summary service and receive a summary of the suspicious financial data from the summary service, the processor including a summary evaluation service and a prompt generation service, the server being in electronic communication with a database for storing the suspicious financial data, performing operations which may include: receiving the suspicious financial data from the database; with the prompt generation service, based on the suspicious financial data, generating a prompt; transmitting the suspicious financial data and the prompt to the summary service; in real time, receiving from the summary service a summary of the suspicious financial data, where the summary may include natural language in a sentence-by-sentence format; and with the summary evaluation service, for each sentence of the summary: calculating a cumulative perplexity of the sentence and at least one previous sentence; calculating a cumulative perplexity difference between the cumulative perplexity and a previous value of the cumulative perplexity; and if the cumulative perplexity or the cumulative perplexity difference exceeds a threshold value, triggering an automated action. Other embodiments of this aspect include corresponding computer systems, apparatus, and computer programs recorded on one or more computer storage devices, each configured to perform the actions of the methods.

Implementations may include one or more of the following features. In some embodiments, the automated action may include, based on the suspicious financial data, the prompt, and the cumulative perplexity or the cumulative perplexity difference: with the prompt generation service, revising the prompt; and sending the revised prompt to the summary service. In some embodiments, the automated action may include instructing the summary service to: correct the sentence or a previous sentence; and continue generating the summary. In some embodiments, calculating the cumulative perplexity of the sentence and at least one previous sentence involves calculating a cumulative perplexity of the sentence and all previous sentences. In some embodiments, calculating the cumulative perplexity difference between the cumulative perplexity and a previous value of the cumulative perplexity involves calculating a cumulative perplexity difference between the cumulative perplexity and a most recent previous value of the cumulative perplexity. In some embodiments, the operations further may include: displaying, to a user, a graph of the cumulative perplexity over time; and updating the graph each time a new sentence is receives. In some embodiments, the operations further may include: displaying, to a user, a graph of the cumulative perplexity difference over time; and updating the graph each time a new sentence is received. In some embodiments, the suspicious financial data may include structured information that may include at least one of: a financial document, a transaction report, a transaction record, a transaction history, a regulatory filing, a regulatory update, a fraud pattern, an investigative summary, a financial dataset, or a customer profile. In some embodiments, the suspicious financial data may include unstructured information that may include at least one of: a customer communication, a legal document, a regulatory guideline, a geopolitical risk factor, or a description of legal implications. In some embodiments, the summary may include a suspicious transaction report, a fraud investigation report, an insider trading investigation report, or an anti-money-laundering investigation report. Implementations of the described techniques may include hardware, a method or process, or computer software on a computer-accessible medium.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the cumulative perplexity measurement system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a schematic, diagrammatic representation, in block diagram form, of a fraud management system 100 that includes a cumulative perplexity measurement system, in accordance with at least one embodiment of the present disclosure.

FIG. 2 is schematic, diagrammatic representation, in block diagram form, of cumulative perplexity measurement system 200 in accordance with at least one embodiment of the present disclosure.

FIG. 3 is a schematic, diagrammatic representation, in block diagram form, of an example cumulative perplexity measurement system 300, in accordance with at least one embodiment of the present disclosure.

FIG. 4 is a schematic, diagrammatic representation, in block diagram form, of an example cumulative perplexity measurement system 300, in accordance with at least one embodiment of the present disclosure.

FIG. 5 is a schematic, diagrammatic representation, in block diagram form, of an example cumulative perplexity measurement system 500, in accordance with at least one embodiment of the present disclosure.

FIG. 6 is a schematic, diagrammatic representation, in block diagram form, of an example cumulative perplexity measurement system 500, in accordance with at least one embodiment of the present disclosure.

FIG. 7 is a schematic, diagrammatic representation, in flow diagram form, of an example cumulative perplexity measurement method 700, in accordance with at least one embodiment of the present disclosure.

FIG. 8 is a schematic, diagrammatic representation, in flow diagram form, of an example cumulative perplexity measurement method 800, in accordance with at least one embodiment of the present disclosure.

FIG. 9 is s schematic, diagrammatic representation, in flow diagram form, of an example cumulative perplexity measurement method 900, in accordance with at least one embodiment of the present disclosure.

FIG. 10 is a graph 1000 showing cumulative perplexity 1010 as a function of sentence number or sentence index 1020, in accordance with at least one embodiment of the present disclosure.

FIG. 11 is a graph 1100 showing cumulative perplexity difference 1110 as a function of sentence number or sentence index 1120, in accordance with at least one embodiment of the present disclosure.

FIG. 12 is a schematic, diagrammatic representation, in block diagram form, of a fraud management system 1200 that includes the cumulative perplexity measurement system, in accordance with at least one embodiment of the present disclosure.

FIG. 13 is a screen display 1300 of a dashboard visualization for an example cumulative perplexity measurement system, in accordance with at least one embodiment of the present disclosure.

FIG. 14 shows a screen display 1400 comparing a fluent text 1410 and a non-fluent text 1420, in accordance with at least one embodiment of the present disclosure.

FIG. 15 is a schematic, diagrammatic representation, in block diagram form, of an example cumulative perplexity measurement system 1500, in accordance with at least one embodiment of the present disclosure.

FIG. 16 is a schematic, diagrammatic representation, in flow diagram form, of an example cumulative perplexity measurement method 1600, in accordance with at least one embodiment of the present disclosure.

FIG. 17 is a schematic, diagrammatic representation of a processor circuit 1750, in accordance with at least one embodiment of the present disclosure.

### DETAILED DESCRIPTION

In accordance with at least one embodiment of the present disclosure, a cumulative perplexity measurement system is provided which addresses the deficiencies in machine-generated text by using cumulative perplexity metrics to detect when and where a text has diverged from fluency (e.g., through a shift in tone, relevance, or subject matter), and to take appropriate corrective measures such as revising an LLM prompt. The system can analyze complex financial narratives in real-time, ensuring that the generated content remains contextually accurate and aligned with financial crime detection goals.

LLMs face challenges in maintaining narrative coherence, especially when generating long, data-rich reports. To address the deficiencies in LLM-generated text, the present disclosure incorporates cumulative perplexity, which provides real-time feedback during the text generation process, helping to ensure that generated content maintains narrative continuity and relevance, especially in long and complex financial crime reports.

Cumulative perplexity is a key innovation in the present disclosure that significantly enhances the real-time evaluation of AI-generated content in the financial crime domain. Unlike traditional perplexity, which evaluates an entire document after it has been generated, cumulative perplexity evaluates text incrementally as it is produced. This real-time evaluation ensures that potential disruptions, such as topic shifts or tonal inconsistencies, are identified immediately, allowing for corrective actions to be taken during the report generation process.

The introduction of cumulative perplexity addresses this by providing a real-time mechanism for evaluating the consistency of generated text. This ensures that the generated content remains focused, contextually relevant, and free from inconsistencies that could undermine the integrity of financial crime detection efforts. The integration of cumulative perplexity with LLMs enables real-time monitoring and refinement of the output, ensuring that generated reports are of high quality and meet the rigorous standards required in financial crime investigations.

In financial crime detection, maintaining a consistent and focused narrative is critical for ensuring that reports and analyses remain relevant and accurate. For example, if an AI model generating a report on a money laundering case suddenly shifts focus to irrelevant details, the cumulative perplexity score will spike, signaling the need for adjustment. This continuous feedback helps ensure that the AI model stays focused on the task, leading to more reliable, coherent, and actionable financial crime detection reports.

Retrieval-Augmented Generation (RAG) combines the power of information retrieval with the generative capabilities of LLMs. By retrieving relevant external data from sources such as transaction databases, regulatory updates, or fraud patterns, RAG systems improve the contextual accuracy of generated content. This integration allows the AI model to generate responses and reports that are informed by the most current, relevant data available.

When combined with cumulative perplexity, RAG systems gain the ability to evaluate and refine the generated content in real-time, ensuring that retrieved data is seamlessly incorporated into the narrative without disrupting its flow. This dynamic feedback mechanism ensures that the generated reports remain coherent, contextually relevant, and aligned with the investigative goals, making them more reliable and actionable for financial crime detection.

Agentic AI refers to autonomous systems that perform tasks and make decisions based on predefined objectives, without the need for continuous human intervention. In financial crime detection, agentic AI is used to automate tasks such as generating reports, flagging suspicious activities, holding or blocking transactions, and recommending further actions. These systems are often integrated with ML models, NLP techniques, and other AI technologies to process large datasets and generate actionable insights.

The integration of cumulative perplexity into agentic AI systems ensures that the generated content maintains consistency and clarity. As the agentic AI generates reports or flags suspicious activities, cumulative perplexity continuously evaluates the coherence of the text, providing real-time feedback that allows the system to self-correct any narrative inconsistencies. This enhances the reliability and precision of the AI-generated content, ensuring that financial crime investigations proceed efficiently and with high confidence in the generated insights.

Financial crime detection and reporting are vital functions for financial institutions aiming to identify and mitigate risks associated with illicit activities, such as money laundering and fraud. The advent of AI has allowed for the automation of these processes, improving efficiency and reducing the burden on human analysts. However, ensuring the quality and coherence of AI-generated reports remains a challenge, particularly when dealing with complex and multidimensional data.

The integration of cumulative perplexity into AI-driven financial crime detection systems addresses this challenge by continuously tracking the narrative flow of generated reports. This real-time evaluation ensures that reports remain focused, clear, and aligned with the goals of the investigation. By detecting and flagging inconsistencies in tone or topic, cumulative perplexity helps ensure that users such as financial analysts receive high-quality, actionable reports, thereby improving decision-making and the ability to identify potential financial crimes effectively.

Natural Language Processing (NLP) encompasses a range of tasks that involve understanding, generating, and manipulating human language. To ensure the quality of text generated by machine learning models, especially in tasks like text generation, summarization, and machine translation, various NLP metrics are used. These metrics are essential in evaluating the performance of models, verifying their outputs, and validating the appropriateness of the generated text in relation to its intended use.

Perplexity, in its traditional form, serves as a valuable tool for assessing the overall performance of language models. It measures how well a model predicts a sequence of words, quantifying the level of uncertainty or “surprise” the model experiences when predicting the next word. The lower the perplexity, the better the model's predictions are, meaning the model is less surprised by the text and its predictions are more accurate. Conversely, a higher perplexity score indicates greater uncertainty in the model's predictions, suggesting that the generated text deviates more from expected patterns.

Mathematically, perplexity is calculated as the exponential of the entropy, or the average log-likelihood, of the model's predictions. The formula for perplexity can be written as:

$$PP ( {w}_{1} , {w}_{2} , … , {w}_{n} ) = {e}^{- \frac{1}{N} {\sum }_{i = 1}^{N} log P ( {w}_{i} \vert {w}_{i - 1} , {w}_{i - 2} , … , {w}_{1} )} \qquad EQN . 1$$

where P(wᵢ|wᵢ₋₁, wᵢ₋₂, . . . , w₁) is the conditional probability of each word wᵢ given the preceding words, and N is the total number of words. This equation measures the ability of the model to predict the next word in the sequence by examining the likelihood of the words that follow it. For a well-performing model, the perplexity will be lower, reflecting more accurate predictions.

In its simplest application, perplexity is calculated across entire texts or large segments of text, offering an aggregate score that provides a high-level indication of how well the model is performing in terms of predicting word sequences

Traditional perplexity metrics are designed to evaluate the overall fluency of text generation by measuring how well a model predicts word sequences across large segments of text. While this broad measure provides a general sense of a model's predictive ability, it falls short in detecting finer details, such as shifts in topic, tone, or context. For example, in financial crime reports where maintaining topic consistency is critical, traditional perplexity may not capture when the model unexpectedly changes focus or introduces irrelevant information. These shifts, which could affect the quality of the generated content, may not cause significant changes in the perplexity score, but they can significantly impact the coherence and usefulness of the text for specific applications.

Beyond the basic formulation, there are several types of perplexity, each suitable for different contexts. To fully understand these types, it's useful to first grasp the concept of a token, which plays a central role in how perplexity is calculated. In the context of NLP, a token refers to a unit of text that the model processes. This can be a word, a sub-word (e.g., prefixes, suffixes, or roots), or a character, depending on the tokenization scheme used by the model. Tokenization is the process of breaking down the raw text into smaller, manageable units (tokens) that the model can understand and predict. For instance, the sentence “AML regulations are crucial” might be tokenized as the individual words: [“AML”, “regulations”, “are”, “crucial” ]. Some models might tokenize sub-word units like “regul” and “ations” instead of whole words.

The token-level perplexity measures the model's ability to predict the next token based on the preceding tokens. At the token level, perplexity assesses how well the model is able to predict individual tokens in a sequence, considering the context provided by the previous tokens. For example, if the model is tasked with predicting the next word or sub-word, it uses the context of the preceding tokens (like “AML regulations”) to make its prediction. If the next token is “are,” the model's perplexity score will reflect how predictable that word is given the context. Lower perplexity values indicate that the model can predict the next token with high confidence, meaning it is not surprised by the sequence. Conversely, high perplexity means the model's prediction is uncertain, signaling potential areas of inconsistency or difficulty in the generated text.

In more advanced applications, sentence-level perplexity is used. This involves aggregating the token-level perplexities across an entire sentence to provide an overall evaluation of how well the model can predict the sequence of tokens in that sentence. Sentence-level perplexity smooths out the fluctuations found at the token level, offering a broader view of how well the model maintains coherence and consistency over the span of a sentence. It is useful for identifying larger-scale issues in fluency or sentence structure, though it still doesn't fully capture disruptions that might occur within the sentence.

Document-level perplexity goes even further, evaluating the model's performance over longer stretches of text, such as entire paragraphs or documents. This measure considers the entire sequence of tokens throughout the document, helping to capture global patterns and thematic consistency. Document-level perplexity is crucial for tasks that involve the generation of long-form content, such as summaries, reports, or dialogue generation. It provides insights into how well the model can maintain coherence and fluency across larger sections of text. For example, when generating a summary of a financial crime report, document-level perplexity can help evaluate whether the model is able to stay consistent with the topic throughout the entire summary, without introducing irrelevant or off-topic information.

In summary, tokens are the fundamental units upon which perplexity is calculated, with token-level perplexity focusing on immediate word prediction, sentence-level perplexity aggregating predictions across sentences, and document-level perplexity evaluating the coherence and fluency of longer passages. Tokens can range from individual characters or sub-words to complete words, depending on the tokenization process employed by the model. At the token level, perplexity helps assess how well the model predicts each subsequent token based on the context provided by preceding tokens. This allows for an in-depth analysis of how well the model understands and generates words in a sequence, revealing areas where the model might struggle with specific word choices or context-dependent terms.

Sentence-level perplexity takes a broader view, aggregating token-level predictions across entire sentences. By evaluating the predictability of a sentence, sentence-level perplexity helps assess the fluency and coherence of the text at a larger scale. It can detect if the model struggles with maintaining grammatical correctness or producing sentences that feel natural and contextually relevant. This level of perplexity is particularly valuable for evaluating how the model handles sentence structures, word order, and the logical flow of ideas.

Document-level perplexity further expands this evaluation by examining entire paragraphs or documents. It assesses the model's ability to generate coherent and contextually consistent content over extended passages. Document-level perplexity is crucial for applications where long-form text generation is required, such as summarization, report writing, or narrative generation. It provides insights into how well the model can maintain focus on the main topic, avoid drifts in tone or subject, and ensure a smooth progression of ideas throughout the document. This type of perplexity is particularly valuable when generating complex documents, such as in specialized domains like financial crime detection, where maintaining thematic coherence and consistency is critical.

Each type of perplexity has its strengths and serves a unique role in evaluating how well a model generates and maintains text across different scales, from individual words to entire documents. Token-level perplexity offers a fine-grained view of word prediction accuracy, sentence-level perplexity evaluates the local coherence and fluency within sentences, and document-level perplexity provides a holistic view of long-form content generation. Understanding these types helps tailor the use of perplexity in various NLP applications, from simple word prediction to complex document generation, enabling more precise evaluations of text generation quality across a wide range of tasks and domains. Furthermore, these levels of perplexity offer the flexibility to adapt the evaluation process to the specific requirements of the application, whether the goal is to generate grammatically accurate text, maintain topic consistency, or ensure that the generated content aligns with complex, domain-specific expectations.

Despite its widespread use, traditional perplexity has limitations in applications where fine-tuning the quality of generated content is crucial, particularly in specialized domains like financial crime detection. In environments that require high precision and coherence, such as Anti-Money Laundering (AML) or fraud detection reports, the standard perplexity measure may not effectively capture the subtle shifts in content quality. These applications demand consistent narrative flow, appropriate tone, and the ability to maintain focus on the relevant topics. Traditional perplexity struggles to identify disruptions such as abrupt topic changes or tonal inconsistencies. As even minor deviations in these areas can greatly impact the usefulness and accuracy of the generated content, relying on perplexity alone is inadequate for ensuring that content remains reliable and suitable for decision-making in high-stakes environments like financial investigations.

For instance, when large language models (LLMs) are employed in financial crime applications to summarize suspicious transaction reports or assist in fraud detection, it is crucial that the generated text remains on-topic and stylistically appropriate. Traditional perplexity scores are less sensitive to the granular changes that occur as the model progresses through the text. The inability to identify these nuanced shifts leaves a gap in the model's evaluation process. Although perplexity effectively measures the overall fluency of the text, it does not provide sufficient insights into how the model handles transitions or thematic changes that may be critical in specialized tasks like financial investigations.

Moreover, perplexity scores, being sensitive to statistical patterns in word sequences, may not capture the full richness of human understanding, which includes not just the prediction of the next word, but also the logical flow and thematic consistency over long-form documents. In areas such as Anti-Money Laundering (AML) or fraud detection, where the interpretation of complex, multidimensional data may be necessary, traditional perplexity metrics may fail to flag where a model has lost coherence or shifted its focus inappropriately. For instance, in a report that moves from summarizing suspicious transactions to abruptly discussing irrelevant legal regulations, traditional perplexity may not indicate this inconsistency because the word sequences may still be statistically plausible. In these cases, the model might still generate grammatically correct and fluent text, but its thematic or contextual relevance could be disrupted, leading to a report that is no longer aligned with the intended focus or purpose.

This is where advanced evaluation methods of the present disclosure are helpful, which methods go beyond a single score and consider the evolution of the text as it is generated. These methods preferably should track not only the immediate predictive accuracy but also monitor how well the content flows in terms of coherence and relevance across longer stretches of text. This can provide a deeper understanding of how a model handles transitions between ideas, the continuity of its reasoning, and the preservation of thematic consistency. This level of detail may not be captured by traditional perplexity alone, as it fails to consider these broader aspects of narrative structure.

Thus, the current state of NLP evaluation tools, while effective in some general applications, may fall short in highly specialized domains like financial crime detection, where maintaining narrative coherence and contextual integrity is paramount. In such contexts, even small disruptions in the narrative flow can have significant consequences, such as misinterpreting financial data, overlooking important correlations, or generating recommendations that are not aligned with the investigation's objectives. This limitation necessitates the development of more sophisticated, real-time metrics that can track the progression of text generation in a way that traditional perplexity does not, providing a more detailed analysis of how the model handles shifts in topic, tone, and context. By offering real-time insights into the evolution of generated content, these advanced evaluation techniques could enable more precise interventions, allowing for immediate corrections when the model veers off course and ensuring that generated text remains both coherent and contextually accurate throughout.

Relationship with Other Evaluation Metrics

Perplexity is often used in conjunction with other metrics to provide a comprehensive evaluation of text quality. For example, it can be combined with human evaluation methods to offer qualitative insights into model performance. Metrics like BLEU (Bilingual Evaluation Understudy), ROUGE (Recall-Oriented Understudy for Gisting Evaluation), and METEOR (Metric for Evaluation of Translation with Explicit ORdering) are commonly used alongside perplexity for tasks like machine translation and text summarization. While perplexity provides a quantitative measure of prediction accuracy, these complementary metrics focus on aspects such as content relevance, fluency, and grammatical correctness, which enrich the evaluation process. The integration of multiple evaluation tools creates a more nuanced understanding of how well a model is performing in real-world applications, allowing for better-targeted improvements.

### Applications of Perplexity in Diverse NLP Tasks

Beyond its foundational use in language modeling, perplexity may play a critical role across a wide array of NLP tasks. For example, in text summarization, a model that generates concise summaries with low perplexity may be better at predicting coherent and relevant content based on the source material. In question-answering systems, perplexity can guide the model towards more accurate responses by ensuring that the model maintains high fluency and relevance in its answers. Similarly, in dialogue systems, maintaining low perplexity helps ensure that responses are contextually appropriate and conversationally fluent. The versatility of perplexity across different NLP tasks underscores its importance as a general-purpose evaluation metric, adaptable to numerous real-world applications.

In financial crime detection, the generation of coherent, contextually accurate, and reliable narratives from large-scale transaction data is critical. However, current AI systems, particularly generative language models, may struggle with maintaining narrative consistency and coherence in complex domains like Anti-Money Laundering (AML) and fraud detection. These challenges can result in reduced accuracy, reliability, and effectiveness, directly impacting the quality of financial crime investigations and regulatory compliance efforts.

### Loss of Coherence in Long-Form Text Generation

Generative AI models, particularly deep learning models like transformers (e.g., GPT-3, GPT-4), have become helpful tools in the financial crime detection landscape. These models are employed to generate long-form content, such as detailed reports, summaries, risk assessments, and actionable recommendations. Their ability to process and analyze vast amounts of textual data makes them powerful assets for handling large-scale financial datasets, such as transaction records, customer profiles, and legal documents. However, despite their impressive capabilities, these models often struggle with maintaining narrative coherence over extended periods, especially when tasked with synthesizing and summarizing complex, multidimensional information.

In the context of financial crime detection, maintaining coherence in long-form text generation may be crucial. Reports and summaries may need to be consistent, focused, and contextually relevant to the investigation at hand. AI models that generate incoherent or fragmented narratives can severely undermine the value of the content, making it difficult for investigators to extract actionable insights. One of the primary challenges with these models is that, as the length of the generated text increases, the models may tend to lose track of the broader narrative structure, resulting in a breakdown of coherence. The further the generation proceeds, the greater the chance of the narrative veering off-topic, introducing inconsistencies, or misrepresenting the core message.

Financial crime reports, for instance, often require extensive details that connect various pieces of information—such as suspect activities, transaction histories, and legal implications—into a coherent, narrative structure. However, as the report grows longer, there may be an increasing likelihood that the model will introduce irrelevant or tangential topics. This loss of coherence can manifest in several ways: for example, the model might shift abruptly from discussing a financial transaction to introducing an unrelated topic like medical terminology, historical data, or a non-relevant financial concept that has no bearing on the investigation. Such disruptions in the narrative flow can confuse investigators, lead to misinterpretation, or result in the overlooking of critical details.

These narrative disruptions, although potentially glaring to human readers, are not always flagged by traditional evaluation metrics like perplexity. Perplexity, as it operates in the context of large segments of text, provides an aggregate measure of the model's overall predictive accuracy but does not effectively capture local inconsistencies within the text. This means that while perplexity can indicate a general sense of fluency and coherence, it may fail to pinpoint the specific points where the narrative has deviated from the intended topic or introduced irrelevant information. As a result, subtle disruptions in coherence may go unnoticed, especially in long-form content where the text's length and complexity increase the likelihood of inconsistencies.

In environments like financial crime investigations, where the focus is on tracking specific patterns of illicit activities, such as money laundering or fraud, maintaining a consistent and logical flow of information may be essential. Investigators rely on AI-generated content to provide clear, focused insights that guide their decision-making. If the generated text lacks coherence or drifts off-topic, the ability of investigators to make accurate judgments is compromised. In particular, even seemingly minor shifts—such as a sudden discussion of unrelated regulations or background information—can significantly affect the interpretation of the data and the recommendations provided by the AI system.

The inability of traditional methods to detect and correct these shifts in real time may further compound the problem. While a human reader might quickly identify an irrelevant or out-of-context passage, generative AI models, without real-time feedback mechanisms, may continue generating text without addressing these inconsistencies. As a result, long-form reports or summaries generated by AI systems may require extensive post-editing to restore coherence and relevance, leading to delays and inefficiencies in the investigative process.

Additionally, the loss of coherence in long-form text generation is exacerbated by the increasing complexity of the data being processed. Financial data often comes with intricate relationships, multiple variables, and nuanced interpretations. AI models that are trained on broad datasets may not always understand the subtle connections between pieces of data specific to a financial crime investigation. When tasked with generating reports that draw from these complex datasets, models may fail to sustain the narrative thread, leading to fragmented or incoherent summaries that do not adequately capture the essence of the investigation.

To address these challenges, advanced evaluation techniques may be helpful, including methods that go beyond traditional perplexity and provide a real-time assessment of the narrative flow. These techniques allow for the continuous monitoring of how well the model adheres to the central themes and objectives of the report, ensuring that any abrupt shifts in topic, tone, or relevance are detected and corrected before they disrupt the investigation process. Furthermore, these real-time feedback mechanisms enable prompt interventions, allowing prompt engineers and financial analysts, whether human or automated, to refine the AI's output, improving the reliability and coherence of the generated content.

### Inability to Detect Topic Drift, Tone Shifts, and Style Inconsistencies

One of the most significant challenges in financial crime detection may be the ability to detect topic drift, tone shifts, and style inconsistencies within AI-generated narratives. This problem may be especially prominent in complex investigations such as Anti-Money Laundering (AML) and fraud detection, where maintaining a consistent and professional narrative may be critical. The reports, summaries, and alerts produced by AI systems must generally adhere to a formal, precise, and contextually accurate style, as financial professionals rely heavily on these documents to make informed decisions. Any deviation from the intended tone or inclusion of irrelevant information can compromise the clarity, professionalism, and overall utility of the content.

In these specialized domains, financial crime reports often require a precise tone and style to ensure that they are easily actionable by compliance officers, investigators, and regulatory bodies. These professionals depend on reports that are structured and written in a manner that ensures the information is conveyed clearly and without unnecessary distractions. Reports that lack coherence or shift in tone can lead to confusion, misinterpretation, and, at worst, incorrect decisions that may impact an investigation or a regulatory filing.

Traditional perplexity, while useful for assessing general fluency and predictability, is not designed to detect these subtle, context-dependent shifts in narrative style or tone. It operates primarily at the token or sentence level, measuring the likelihood of individual word sequences without considering the broader context or the narrative flow across paragraphs. As a result, traditional perplexity measures may fail to capture nuanced shifts, such as when a model abruptly switches topics or adopts an inappropriate tone for a particular section of text.

### Example 1: Sudden Shift in Tone from Formal to Casual

Imagine an AI system generating a report on a suspicious financial transaction involving large wire transfers to offshore accounts. The report is supposed to maintain a formal, professional tone throughout, as it will be reviewed by regulators and financial investigators. However, partway through, the report includes a casual, offhand remark such as, “It's pretty strange, right, how these transactions just keep popping up!”

Despite the fact that the rest of the report remains grammatically correct, this sudden shift to a casual tone undermines the credibility and professionalism of the content. The use of informal language in a context that requires precision and authority can cause confusion, leading the reader to question the seriousness of the findings or, worse, dismiss the report as unprofessional. This shift in tone, while easily recognizable to human readers, would likely go undetected by traditional perplexity measures, which may fail to flag the inconsistency. Such shifts can confuse investigators and lead to misinterpretation of the findings, ultimately jeopardizing the success of an investigation or regulatory review.

### Example 2: Irrelevant Topic Introduction in a Fraud Detection Report

Consider an AI-generated report designed to summarize a fraud detection investigation regarding unusual activity in a corporate bank account. The report begins by detailing the transactions and potential red flags that led to the investigation. However, halfway through the report, the AI inexplicably shifts focus, introducing a detailed description of the corporate entity's history of legal disputes, which is unrelated to the investigation at hand.

While the text remains grammatically correct and coherent within the context of the new topic, the shift in focus causes a disruption in the report's relevance. Financial investigators do not need extraneous details about past legal issues when they are trying to understand the current fraudulent activities. This sudden introduction of irrelevant content distracts from the main objective of the report: identifying and analyzing fraudulent behaviors. Traditional perplexity would likely fail to detect this disruption because it only measures the fluency and predictability of word sequences, not the contextual relevance or alignment with the investigation's focus. As a result, the investigator may spend time sifting through unrelated information, wasting valuable resources and potentially overlooking critical insights.

The inability of traditional evaluation methods like perplexity to detect these inconsistencies in real time is a significant issue. In the dynamic field of financial crime detection, it is essential for AI systems to provide continuous, actionable feedback that ensures the generated content remains focused on the investigation at hand. As investigations unfold and new data emerges, the AI must adapt and maintain its narrative coherence throughout the text generation process.

Traditional perplexity's static approach to text evaluation means that any disruptions, such as those demonstrated in the examples above, may not be flagged until after the entire text is generated. By then, the investigator or regulator might already be misled by the irrelevant or inconsistent information. Furthermore, by failing to capture shifts in tone or topic, traditional perplexity may provide limited value in improving the overall quality of AI-generated content in specialized domains like financial crime detection. Investigators may not be able to afford to waste time dealing with content that lacks clarity or consistency, especially when dealing with complex, high-stakes investigations.

### Static Nature of Traditional Perplexity Evaluation

Traditional perplexity metrics may be inherently static-providing a single score for an entire text or large segments of a text, usually reflecting the model's predictive accuracy over the entire sequence. This score may be valuable for assessing overall fluency and for giving a broad measure of the model's ability to predict the next word in a sequence based on prior context. However, traditional perplexity may fail to account for the nuances of narrative evolution throughout the text generation process, particularly in longer documents. It may offer no insight into how the coherence of the text changes or evolves over time, making it an inadequate tool for evaluating content in complex, long-form applications like financial crime detection.

In financial crime investigations, reports, summaries, and case narratives are often developed over multiple stages, with each stage building upon previous sections of content. However, inconsistencies that arise in the earlier stages of generation can propagate and amplify as the text progresses, leading to greater disruption in the narrative flow toward the end. For instance, a subtle topic shift or minor tonal inconsistency at the beginning of a report may not be immediately noticeable, but as the model continues generating content, the resulting lack of coherence can compound, culminating in a report that appears fragmented, disjointed, or off-topic by the end.

The lack of dynamic adjustment may also limit the ability to fine-tune the output while the text is being produced. In the context of long-form content, such as an AI-generated financial crime report, real-time feedback may be essential for refining the model's performance. As the model generates new sections of the report, it should ensure that the text remains aligned with the initial investigation focus, the correct tone, and the relevant details. Traditional perplexity, by providing only a single score at the end of the process, does not facilitate this fine-tuning. As a result, the model continues to generate content without adjusting its course, which can lead to an accumulation of inconsistencies over the length of the document. Thus, when evaluating generated content in real-time, it may be crucial to have continuous monitoring that not only assesses overall fluency but also tracks the progression of the narrative, ensuring that inconsistencies in topic, tone, or style are flagged and corrected before they can disrupt the integrity of the report

### Increasing Complexity and Volume of Data

The growing complexity and volume of financial data present significant challenges for current AI systems, particularly in the realm of financial crime detection and anti-money laundering (AML) efforts. Financial institutions are processing an ever-increasing amount of data, ranging from vast transaction records to customer profiles, historical patterns, regulatory guidelines, and geopolitical risks. These data sources may be not only abundant but also diverse and multidimensional, making it difficult for traditional detection systems, which rely on manual reviews and rule-based algorithms, to keep pace with the evolving nature of financial crimes.

The sophistication of modern financial crime schemes, including money laundering, fraud, and other illicit activities, may surpass the capabilities of legacy systems. Criminal organizations are employing increasingly complex tactics to conceal their activities, using sophisticated layering techniques, offshore accounts, shell companies, and new technologies like cryptocurrencies to evade detection. Financial institutions may therefore need to sift through large datasets in real time to identify patterns and anomalies that suggest fraudulent activity. However, the sheer volume and complexity of this data make it almost impossible for traditional fraud detection and AML monitoring systems to catch emerging threats effectively. Traditional methods are often not scalable or flexible enough to adapt to the rapidly changing landscape of financial crime, leading to missed opportunities to identify or prevent criminal behavior.

In such a high-stakes environment, the demand for real-time, accurate insights may never have been greater. Financial institutions may need AI-powered systems that can quickly and accurately analyze vast amounts of data, recognizing subtle patterns that may indicate fraudulent or suspicious activities. Generative AI models, particularly those utilizing natural language processing (NLP) techniques, offer great promise in this area. These models can automate tasks such as generating reports, summarizing case files, and identifying patterns in financial transactions, helping investigators detect fraud and money laundering more efficiently. However, as the complexity of financial crime cases increases, so too does the challenge of processing, analyzing, and generating coherent content from vast, heterogeneous datasets.

The volume of data alone can overwhelm traditional AI models, especially when tasked with processing not just transactional data but also unstructured information like customer communications, legal documents, regulatory guidelines, and geopolitical risk factors. While generative AI models may be capable of processing large amounts of data, they can often struggle to maintain coherence and relevance across generation of long-form content, particularly when the narrative spans multiple stages or integrates diverse data sources. Even slight disruptions in narrative coherence—such as a shift in topic, tone, or focus—can lead to substantial errors or missed insights. In the context of financial crime detection, where the accuracy of the generated content is critical to identifying illicit activities, these disruptions can result in overlooked fraudulent transactions, incorrect conclusions, or, in some cases, costly mistakes.

As financial crime cases become more complex and involve larger datasets, the risk of inconsistency or incoherence within AI-generated reports or insights increases. This may make it critical to develop more robust and dynamic systems that can adapt and maintain coherence as long-form content is generated. Tools like cumulative perplexity can address this issue by offering real-time feedback on narrative consistency, allowing the model to self-correct in real time during the generation process. By continuously monitoring the model's output, determination of cumulative perplexity can ensure that the content remains relevant, coherent, and aligned with the investigation's objectives.

Real-time, fine-grained evaluation also plays an essential role in ensuring the relevance of AI-generated content in dynamic, fast-paced environments like financial crime detection. As new data is introduced throughout the investigative process, the AI model may need to adapt its output accordingly. A sophisticated real-time evaluation system that can continuously monitor and adjust for narrative shifts may therefore be crucial in this context.

The feedback mechanism should be capable of identifying even the most minor discrepancies in narrative flow, such as a shift in focus, sudden change in tone, or the introduction of unrelated facts. By providing immediate and granular feedback, this empowers prompt engineers and financial analysts, whether human or automated, to make quick adjustments, improving the accuracy and efficiency of the model's output. This may be especially important in complex fraud detection systems, where time is often of the essence and the quality of the generated content may directly impact the timeliness and effectiveness of decision-making and the detection of financial crime.

Moreover, real-time evaluation can also support the ongoing optimization of AI models, as it allows for the identification of common narrative disruptions or patterns that affect the generated content. With continuous monitoring, AI systems can be fine-tuned to better handle the challenges specific to financial crime detection. Over time, this real-time evaluation system can help improve the overall performance of the model, increasing its ability to generate consistently high-quality, relevant content while reducing the need for manual intervention.

### Lack of Actionable Feedback for Investigators

A significant challenge in the current landscape of AI-driven financial crime detection systems is a lack of actionable feedback provided to human investigators, particularly accurate, real-time feedback. While AI models have the potential to generate vast amounts of data and assist in financial crime investigations, the reports they produce should not only be accurate and reliable but also actionable. In the context of complex financial crime cases, investigators rely heavily on AI-generated reports to make informed, timely decisions. However, when these reports contain inconsistencies, irrelevant details, or lack narrative coherence, the ability of investigators to make quick and accurate judgments may be severely impaired.

In an example, during a fraud investigation, an AI system that uses cumulative perplexity could dynamically assess the coherence of the report as it is generated. If the AI model begins to deviate from the main focus—say, by discussing irrelevant data points or presenting unrelated legal arguments—cumulative perplexity would immediately flag this disruption. The AI could then self-correct, ensuring that the report remains focused on the fraudulent activities at hand. This level of dynamic intervention may significantly improve the quality and relevance of the AI-generated content, empowering investigators to act more quickly and effectively.

In addition to improving the efficiency of investigators, real-time feedback may also enable AI systems to become more adaptive over time, and thus represents an improvement in machine learning. As AI-generated content is continuously monitored and refined, the system can learn from past inconsistencies and improve its ability to maintain coherence and relevance in future outputs. This ongoing refinement is particularly important in financial crime detection, where the landscape is constantly evolving, and investigators must stay ahead of increasingly sophisticated tactics employed by criminals.

Cumulative perplexity, a novel aspect of the present disclosure, provides a dynamic evaluation by calculating perplexity after each sentence is generated, rather than once for the entire document. This incremental measurement enables the detection of immediate changes in the narrative flow, which can be attributed to topic drift, tone shift, or the introduction of irrelevant information.

The mathematical formulation of traditional perplexity may be expressed as:

$$Perplexity = exp ( - \frac{1}{N} {\sum }_{i = 1}^{N} log P ( {w}_{i} \vert {w}_{1} , … , {w}_{i - 1} ) ) \qquad ( EQN . 2 )$$

where P(wᵢ|wᵢ₋₁, wᵢ₋₂, . . . , w₁) is the conditional probability of the i-th word given its preceding context, and N is the total number of tokens in the sequence. This traditional measure aggregates the likelihood of predicting the next word, providing a high-level assessment of model fluency.

In contrast, cumulative perplexity, as described herein, operates incrementally, adjusting after each generated sentence. It could also be adjusted after smaller or larger tokens, e.g., sentence fragments, a specified number of sentences (e.g., 2, 3, 4, or 5 sentences), or a paragraph or two. The cumulative calculation for a text sequence of sentences (or other sub-document portions) becomes:

$$Cumulative {Perplexity}_{sentence i} = {\prod }_{j = 1}^{i} exp ( - \frac{1}{{N}_{j}} {\sum }_{k = 1}^{{N}_{j}} log P ( {w}_{k} \vert {w}_{1} , … , {w}_{k - 1} ) ) \qquad ( EQN 3 )$$

This metric provides a running tally of perplexity values, tracking how the model's ability to predict the next word evolves as more text is generated. A significant change in perplexity from one sentence to the next flags potential disruptions in narrative coherence, such as a shift in topic or tone. By measuring the difference in cumulative perplexity between consecutive sentences, the system can detect specific points of narrative instability.

### Detecting Narrative Shifts

One advantage of cumulative perplexity lies in its sensitivity to localized inconsistencies. By calculating the perplexity after each sentence, the cumulative perplexity measurement system of the present disclosure can detect when the narrative flow starts to diverge, allowing for prompt corrections before these shifts propagate. For instance, in the case of a report on financial crime, if the model suddenly switches from discussing illicit transactions to unrelated legal jargon or a medical topic, the perplexity score will spike, signaling an anomaly in the flow of the report.

Consider the following example where a financial crime report is being generated:

Sentence 1: “AML regulations are crucial for financial institutions to combat illicit activities like money laundering.”

Sentence 2: “These regulations help ensure that funds used in criminal activities, which can be as complex and intricate as the network of arteries in the human body, are identified and seized.”

Sentence 3: “Speaking of arteries, the aorta is the largest blood vessel in the body, responsible for carrying oxygenated blood from the heart.”

Traditional perplexity might show a steady low or moderately low value for the entire text, suggesting fluency and coherence. However, cumulative perplexity may instead reflect a sharp increase in value after the second sentence, as the sudden shift in topic (from financial crime to medical terminology) introduces unpredictability. This increase in perplexity serves as an indicator of narrative inconsistency, prompting a revision of the model's focus to restore coherence and minimize the frequency of or avoid such sudden shifts in topic.

Cumulative perplexity enables real-time evaluation of the text as it is produced, giving the system immediate feedback on narrative consistency. For example, if a model is generating a report on suspicious financial transactions and introduces irrelevant information partway through, cumulative perplexity can detect this shift immediately, even in real-time or promptly thereafter. This can allow for corrective measures—whether through adjusting the model's focus, modifying (or deleting or adding) text following a sharp change in cumulative perplexity, or altering the input prompt—to restore the narrative's consistency. This real-time monitoring and correction system is invaluable in high-stakes environments like financial crime detection, where even small disruptions in narrative coherence can have significant implications.

The present disclosure aids substantially in the generation of automated summaries and reports, by improving the ability of an LLM to stay focused on a particular task and tone, even across large texts generated from large datasets. Implemented on a processor in communication with a database and a text generation system such as a large language model, the cumulative perplexity measurement system disclosed herein provides practical improvements in the machine generation of fluent text. This improved perplexity measurement process transforms a non-fluent text into a more fluent one, without the normally routine need to have the text reviewed and edited by a human subject matter expert. This unconventional approach improves the functioning of the large language model, by prompting it in real time when changes in perplexity occur, thus enabling the LLM to correct the content and produce more fluent text before it is provided to a user or used in any other process.

The cumulative perplexity measurement system may be implemented as a process at least partly viewable on a display, and operated by a control process executing on a processor that accepts user inputs from a keyboard, mouse, or touchscreen interface, and that is in communication with one or more databases. In that regard, the control process performs certain specific operations in response to different inputs or selections made at different times. Certain outputs of the cumulative perplexity measurement system may be printed, shown on a display, or otherwise communicated to human operators, and/or may be used to trigger automated actions, such as real-time revision of LLM prompts or output. Certain structures, functions, and operations of the processor, display, sensors, and user input systems are known in the art, while others are recited herein to enable novel features or aspects of the present disclosure with particularity.

These descriptions are provided for exemplary purposes only, and should not be considered to limit the scope of the cumulative perplexity measurement system. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one of ordinary skill in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

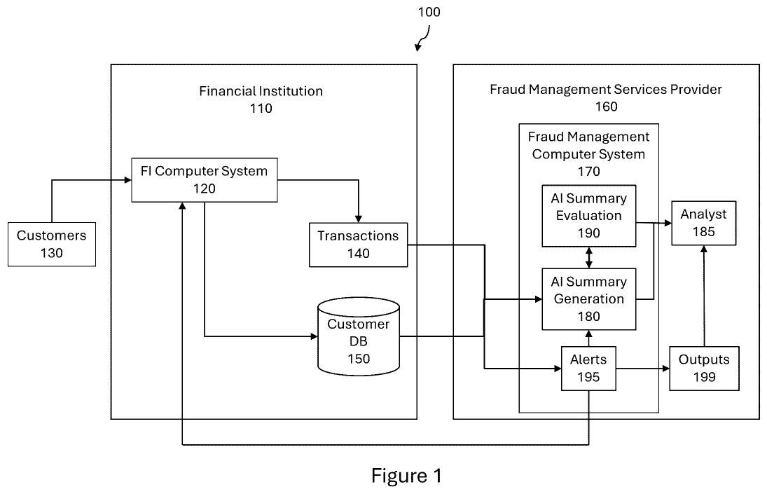

FIG. 1 is a schematic, diagrammatic representation, in block diagram form, of a fraud management system 100 that includes a cumulative perplexity measurement system, in accordance with at least one embodiment of the present disclosure. The fraud management system 100 includes a financial institution 110 and a fraud management services provider 160. Customers 130 interact with a financial institution computer system 120 to generate transactions 140 and customer data that is stored in a customer database 150. The transactions 140 and customer data 150 are used by a fraud management computer system 170 to generate alerts 195, and are also received by an AI-based summary generation service 180 (e.g., an LLM), which passes a summary or report to an AI-based summary evaluation service 190, which may then request revisions from the AI-based summary generation service 180 based on the summary's cumulative perplexity. The AI-based summary evaluation service 190 then presents a fluent summary to an analyst 185, who may also receive outputs 199 related to the alerts 195.

Block diagrams are provided herein for exemplary purposes; a person of ordinary skill in the art will recognize myriad variations that nonetheless fall within the scope of the present disclosure. For example, any of the blocks described herein may optionally include an output to a user of information relevant to the block, and may thus represent an improvement in the user interface over existing art by providing information (whether static or dynamically updated) that is not otherwise available. Similarly, block diagrams may show a particular arrangement of components, modules, services, steps, processes, or layers, resulting in a particular data flow. It is understood that some embodiments of the systems disclosed herein may include additional components, that some components shown may be absent from some embodiments, and that the arrangement of components may be different than shown, resulting in different data flows while still performing the methods described herein. Before continuing, it should therefore be noted that the examples described above are provided for purposes of illustration, and are not intended to be limiting. Other devices and/or device configurations may be utilized to carry out the operations described herein.

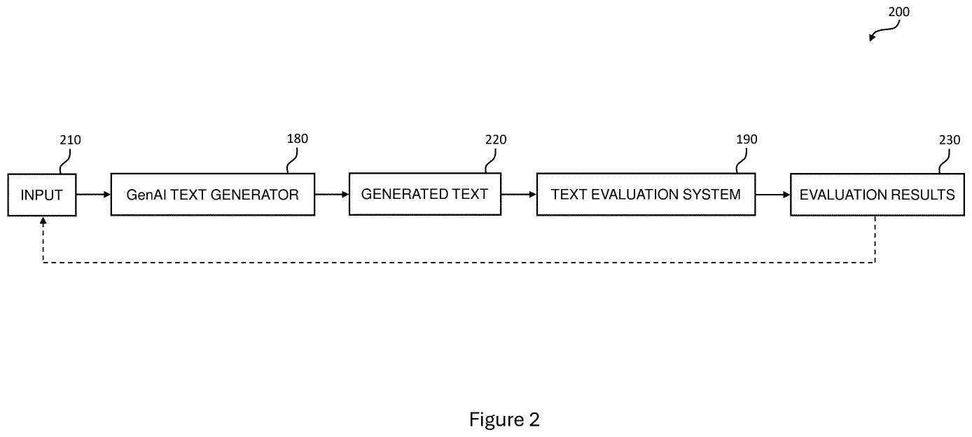

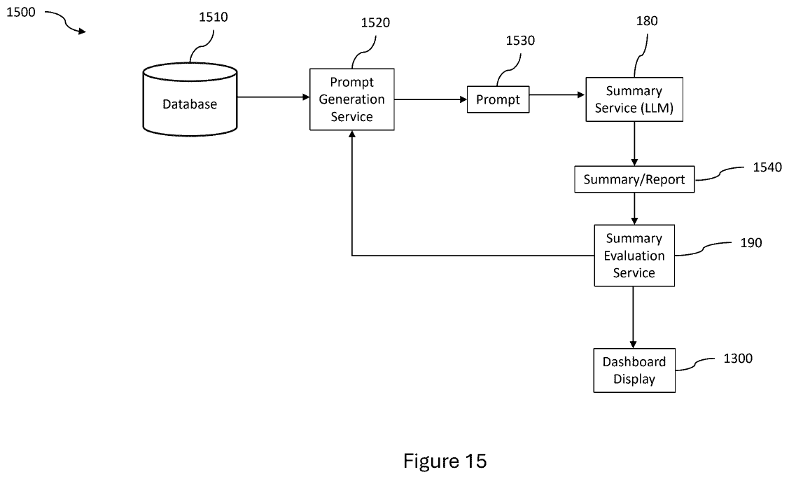

FIG. 2 is schematic, diagrammatic representation, in block diagram form, of cumulative perplexity measurement system 200 in accordance with at least one embodiment of the present disclosure. The cumulative perplexity measurement system 200 receives an input 210, that may for example be a prompt generated by a prompt generation service (see FIG. 15, below), and may include alert data, transaction data, customer data, and unstructured data such as regulatory information. This input 210 is then received by a generative AI (GenAI)-based text generator or summary service 180, which produces generated text 220. The generated text 220 is then received by a text evaluation system or summary evaluation service 190, which produces evaluation results 230 (e.g., an ongoing real-time measurement of cumulative perplexity and/or changes in cumulative perplexity). If the evaluation results 230 indicate a drop in fluency (e.g., an increase in cumulative perplexity) of the generated text 220, then a modified input 210 may be sent to the text generator or summary service 180, which will then generate text 220 based on the modified input 210. If the evaluation results 230 do not indicated a drop in fluency of the generated text 220, then the text generator or summary service 180 will continue generating text 220 based on the original input 210.

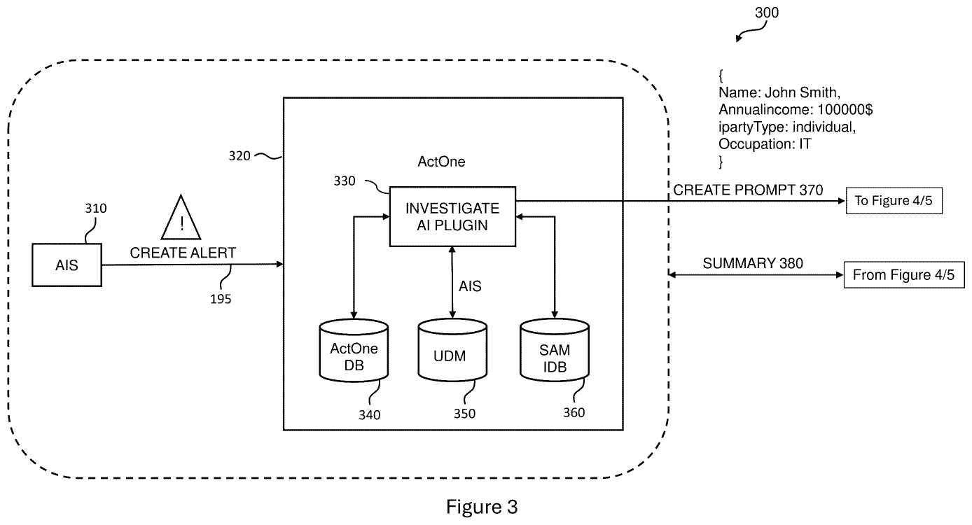

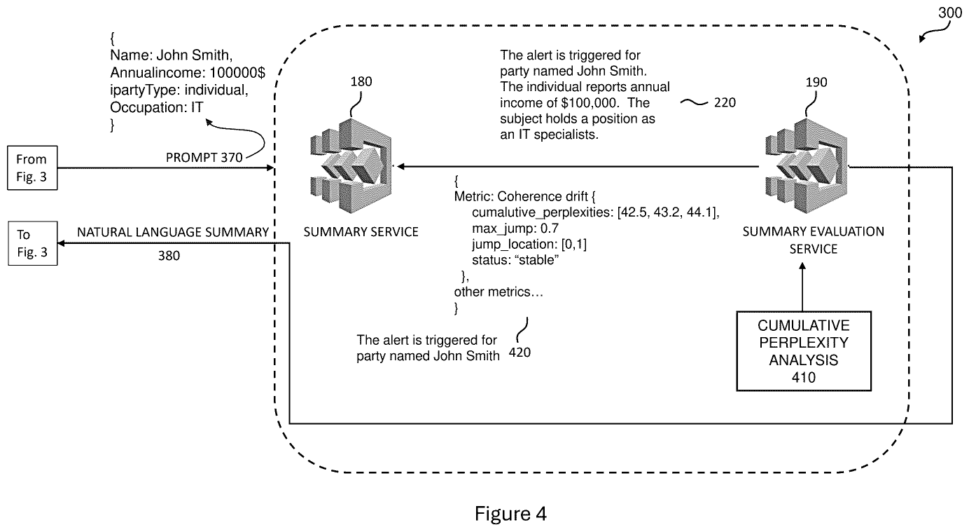

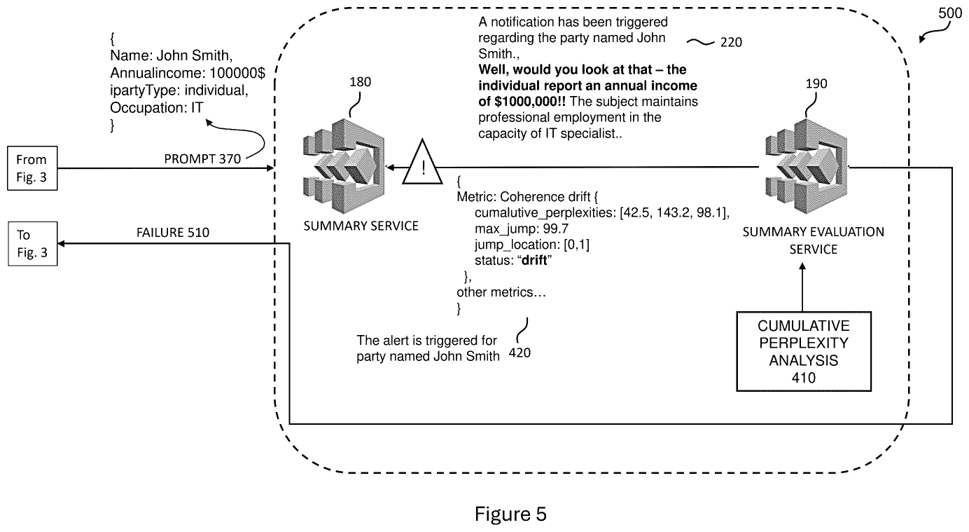

FIG. 3 is a schematic, diagrammatic representation, in block diagram form, of an example cumulative perplexity measurement system 300, in accordance with at least one embodiment of the present disclosure. This diagram demonstrates the successful processing of alert data through a fraud management system. An analytics intelligence server (AIS) 310 (which facilitates the analysis of high-volume data streams, detecting complex suspicious scenarios and behavioral patterns) generates an alert 195, which is passed to a policy manager 320 such as Nice ActOne™, which includes an investigative AI plugin 330 that draws information from a policy manager database 340, unified data manager (UDM) database 350, and a suspicious activity monitoring (SAM) database 360, and then generates a prompt 370, which is passed to a summary service 180 (see FIG. 4 or FIG. 5). The system 300 then receives a natural language summary or report 380 from a summary evaluation service 190 (see FIG. 4 or FIG. 5). In some embodiments, the UDM database provides financial institutions with a single logical and physical data model, as well as a unified and streamlined approach for managing data for the various solutions.

FIG. 4 is a schematic, diagrammatic representation, in block diagram form, of an example cumulative perplexity measurement system 300, in accordance with at least one embodiment of the present disclosure. A prompt 370 is passed to the summary service 180, which produces a provisional summary or generated text 220, which is passed to the summary evaluation service 190 for cumulative perplexity analysis 410, which produces metrics 420. In the example shown in FIG. 4, the metrics 420 indicate a fluent text. Therefore, the generated text 220 is passed back to the policy manager 320 (see FIG. 3) as a natural language summary 380.

FIG. 5 is a schematic, diagrammatic representation, in block diagram form, of an example cumulative perplexity measurement system 500, in accordance with at least one embodiment of the present disclosure. A prompt 370 is passed to the summary service 180, which produces a provisional summary or generated text 220, which is passed to the summary evaluation service 190 for cumulative perplexity analysis 410, which produces metrics 420. In the example shown in FIG. 5, the metrics 420 indicate that coherence drift has been detected. This diagram illustrates how the cumulative perplexity measurement system 500 identifies and flags problematic summaries. While following the same data path from on-premises local software (e.g., software that is installed and runs on computers in the customer's own IT environment) through the policy manager to cloud services, this flow demonstrates the detection of coherence issues. The summary evaluation service 190 identifies significant jumps in perplexity metrics, indicating tonal or stylistic inconsistencies in the generated text 220. Summary evaluation service 190 therefore activates a failure path 510, showing how the system responds to detected anomalies, ensuring quality control in the summary generation process. The failure message 510 is passed back to the policy manager 320 (see FIG. 3), which may display the metrics 420, or graphs derived from the metrics 420, or update such displays in real time, or may take automated actions such as revising the prompt 370 and submitting the revised prompt to the summary service 180.

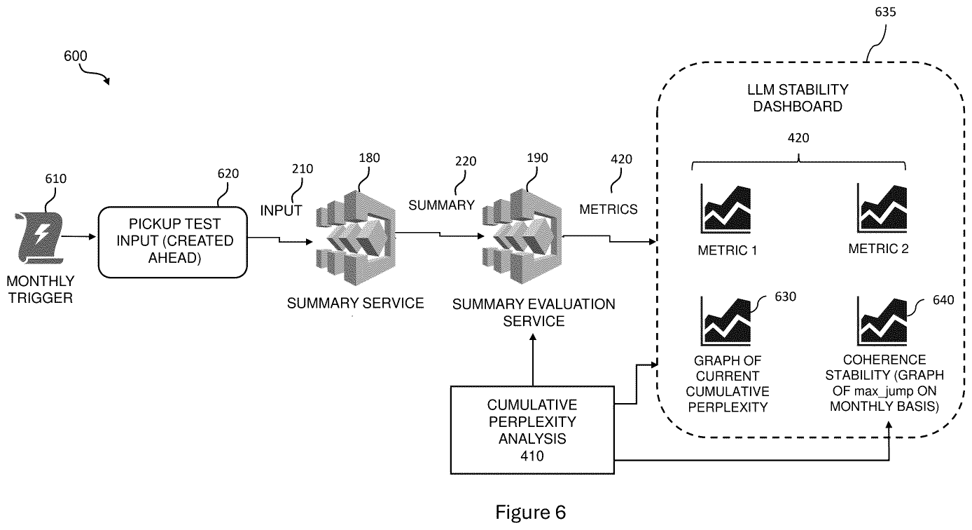

FIG. 6 is a schematic, diagrammatic representation, in block diagram form, of an example cumulative perplexity measurement system 500, in accordance with at least one embodiment of the present disclosure. This diagram illustrates the automated monitoring process for LLM-generated summaries. A monthly trigger initiates test case processing through our Summary Service. The summary evaluation service analyzes the outputs, calculating key stability metrics. Results are visualized on a dashboard featuring different monitoring graphs, including cumulative perplexity trends and coherence stability measurements. This continuous monitoring enables early detection of model performance issues and ensures consistent summary quality.

In the example shown in FIG. 6, a monthly trigger 610 (such as a scheduled action or system process that automatically runs on monthly basis) generates pickup text input 620 (e.g., a fixed text (some test phrase) that the system regularly uses to check if processes are working correctly) which is used as input 210 (e.g., an input to a static prompt that is designed to check the system prompt, or parametrized prompt designed for the same reason) for the summary service 180, which passes a summary 220 to the summary evaluation service 190 for cumulative perplexity analysis 410. The summary evaluation service 190 produces metrics 420 which can then be presented (e.g., on a display) via an LLM stability dashboard 630. The dashboard 635 displays, in numerical or graphical form, the metrics 420, along with a real-time graph 630 of the current cumulative perplexity and a real-time graph 640 of the current cumulative perplexity difference that may for example show the largest jump occurring over the course of the month.

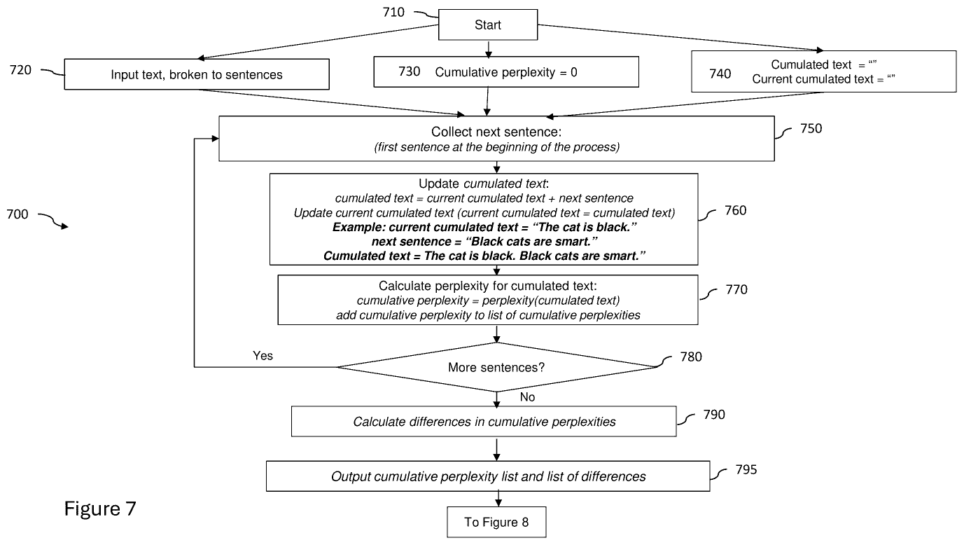

FIG. 7 is a schematic, diagrammatic representation, in flow diagram form, of an example cumulative perplexity measurement method 700, in accordance with at least one embodiment of the present disclosure. FIG. 7 illustrates the automated monitoring process for large language model (LLM)-generated summaries, showing how the system detects and flags problematic shifts in narrative coherence. This step-by-step flow demonstrates how cumulative perplexity is applied to continuously monitor the generated text for inconsistencies, and how those inconsistencies are flagged when they exceed a defined threshold. FIG. 7 provides an overview of how the present disclosure continuously monitors the output, tracking cumulative perplexity metrics to ensure that generated text maintains a high standard of coherence and relevance. As the AI model generates text, the cumulative perplexity is calculated sentence by sentence. The system tracks how much the predictability of each sentence deviates from the preceding ones, allowing it to identify where a shift occurs in the narrative's flow. If a significant jump in perplexity is detected between consecutive sentences, this may suggest that a narrative inconsistency, like topic drift or tone shift, has occurred.

Threshold-Based Flagging: The system compares the difference in cumulative perplexity between consecutive sentences. If this difference exceeds a pre-determined threshold (which may for example be based on the typical variability in perplexity for the model's output), the system flags this shift as potentially problematic. This threshold may be useful because it ensures that only significant disruptions are highlighted, reducing the number of false positives while still being sensitive to critical disruptions that may affect the quality of the report.

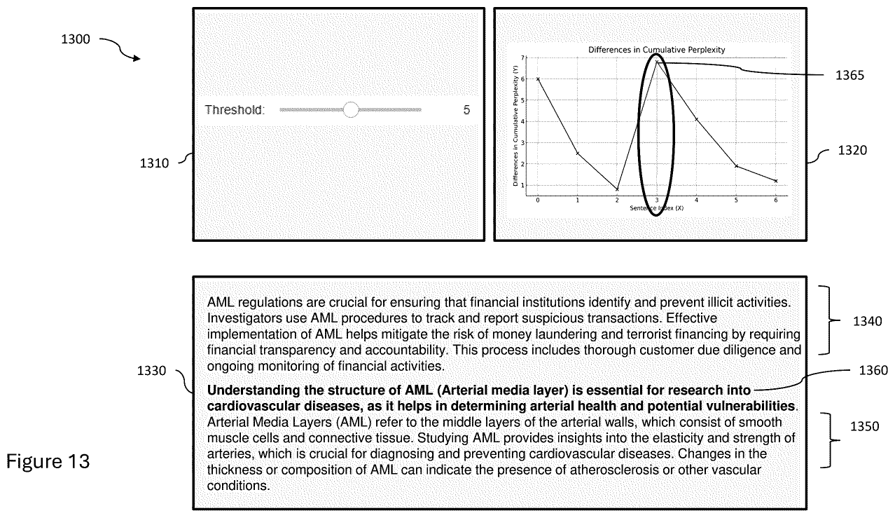

Visualization of the Flagged Disruptions: In a practical implementation of this monitoring system, this step may be accompanied by a visual representation on a dashboard (see FIG. 13). This dashboard could display graphs of cumulative perplexity trends and highlight flagged disruptions, making it easier for prompt engineers or analysts, whether human or automated, to more quickly identify and address narrative issues in the generated text.

Actionable Feedback for Model Adjustment: Once a disruption is flagged, the system may trigger corrective measures. For example, it may prompt the model to revise the most recent sentences or adjust its focus based on the shift detected. This is the real-time correction aspect of the present disclosure-ensuring that the AI model self-corrects as it generates the text, rather than relying on post-processing to fix narrative flaws.

A practical example might for example show the flow of a report where a financial crime investigation is underway, and the narrative flow begins to diverge unexpectedly. For example, the first few sentences of the report may focus on tracking suspicious financial transactions, identifying unusual patterns of behavior linked to potential money laundering. Then, the text may suddenly shift to discussing unrelated regulations about corporate taxation, which has no relevance to the investigation.

In this case, the dashboard would show how the cumulative perplexity scores remain stable in the beginning (when the topic remains consistent) but spike significantly when the unrelated content about taxation is introduced. The system flags this shift in perplexity and notifies the relevant stakeholders, ensuring the model is prompted to correct this drift before generating more irrelevant content.

The ability to detect and address narrative drift in real-time significantly enhances the quality of AI-generated content. In financial crime detection, reports often rely on the precise presentation of data and a consistent narrative thread to support investigations. By detecting topic shifts, tone inconsistencies, or irrelevant details as they arise, the system ensures that the final output remains relevant, accurate, and aligned with the investigative goals. For instance, in Anti-Money Laundering (AML) investigations, even minor disruptions in narrative flow—such as an abrupt switch from discussing suspicious transactions to unrelated legal information—can mislead investigators. By using cumulative perplexity in real-time, the system can ensure that generated reports focus solely on the investigation's objectives, making them more actionable for analysts and compliance officers.

It is understood that the steps of method 700 may be performed in a different order than shown in FIG. 7, additional steps can be provided before, during, and after the steps, and/or some of the steps described can be replaced or eliminated in other embodiments. One or more of steps of the method 700 can be carried by one or more devices and/or systems described herein, such as components of the system 100, system 200, system 300, system 400, system 500, or system 600, and/or processor circuit 1750.

In step 710, the method 700 begins. Execution then proceeds to steps 720, 730, and 740.

In step 720, the method 700 includes receiving input text (e.g., an LLM prompt). Execution then proceeds to step 750.

In step 730, the method 700 includes setting the current cumulative perplexity value to zero. Execution then proceeds to step 750.

In step 740, the method 700 includes setting the cumulated text to null and setting the current cumulated text to null. Execution then proceeds to step 750.

In step 750, the method 700 includes collecting the next sentence from the LLM output. On the first execution of step 750, the next sentence is the first sentence. Execution then proceeds to step 760.

In step 760, the method 700 includes updating the cumulated text, where:
cumulated text=current cumulated text+next sentence
Update current cumulated text (current cumulated text=cumulated text)
In an example, current cumulated text=“The cat is black.”
next sentence=“Black cats are smart.”
Cumulated text=The cat is black. Black cats are smart.”

Execution then proceeds to step 770.

In step 770, the method 700 includes calculating the cumulative perplexity for the cumulated text, where:
cumulative perplexity=perplexity(cumulated text)

The method 700 then includes adding the cumulative perplexity to a list of cumulative perplexities calculated at this step for previous sentences, if any. Execution then proceeds to step 780.

In step 780, then method 700 includes determining whether there are more sentences in the LLM output. If yes, execution returns to step 750. If no, execution proceeds to step 790.

In step 790, the method 700 includes calculating the differences in cumulative perplexity between each step and the step preceding it, and adding these differences to a list of differences. Execution then proceeds to step 795.

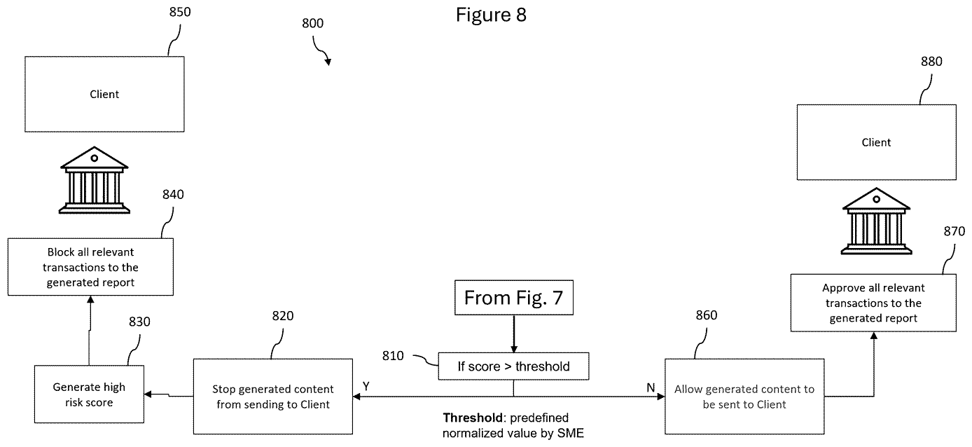

In step 795, the method 700 includes outputting the cumulative perplexity list and the list of cumulative perplexity differences. Execution then proceeds to step 810 of FIG. 8.

Flow diagrams are provided herein for exemplary purposes; a person of ordinary skill in the art will recognize myriad variations that nonetheless fall within the scope of the present disclosure. For example, any of the steps described herein may optionally include an output to a user of information relevant to the step, and may thus represent an improvement in the user interface over existing art by providing information (whether static or dynamically updated) that is not otherwise available.

Similarly, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the steps described herein into a plurality of machine instructions, and may execute these instructions at the rate of several hundred, several thousand, several million, or several billion per second, in a single processor or across a plurality of processors. Such rapid execution may be necessary in order to execute the method in real time or near-real time as described herein. For example, in order to interrupt the LLM while it is still generating text, in a preferred embodiment the system may detect and respond to cumulative perplexity anomalies within 100 milliseconds or less, although some systems will operate more slowly and might require the LLM to delete text and revert back to a previous version of a generated text before the spike in cumulative perplexity occurred.

FIG. 8 is a schematic, diagrammatic representation, in flow diagram form, of an example cumulative perplexity measurement method 800, in accordance with at least one embodiment of the present disclosure.

In step 810, the method 800 includes determining whether the cumulative perplexity score, or a change in cumulative perplexity score, exceeds a threshold value. The threshold value may for example be determined by a human subject matter expert (SME). If yes, execution proceeds to step 820. If no, execution proceeds to step 860.

In step 820, the method 800 includes preventing the LLM-generated text from being sent to the client 850. Execution then proceeds to step 830.

In step 830, the method 800 includes generating a high risk score based on the non-fluent text generated by the LLM. Execution then proceeds to step 840.

In step 840, the method 800 includes blocking all transactions that are relevant to the LLM-generated report. The method 800 is now complete.

In step 860 the method 800 includes allowing the LLM-generated report to be sent to the client 880. Execution then proceeds to step 870.

In step 870, the method 800 includes allowing all transactions relevant to the LLM-generated report to be approved, if warranted by their risk scores. The action can also can include not only approved transactions, but accurate, verified, and/or validated recommendations, summarizations, or insights to the client. The method 800 is now complete.

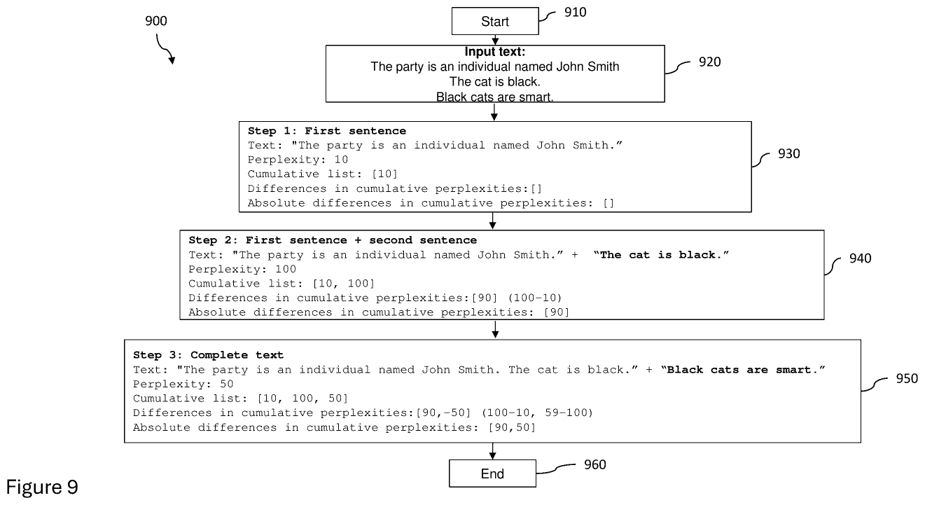

FIG. 9 is s schematic, diagrammatic representation, in flow diagram form, of an example cumulative perplexity measurement method 900, in accordance with at least one embodiment of the present disclosure.

In step 910, the method 900 begins.

In step 920, the method 900 includes receiving the text generated by the LLM. Execution then proceeds to step 930.

In step 930, the method 900 includes calculating the cumulative perplexity and the (null) difference in cumulative perplexity for the first sentence of the text. Execution then proceeds to step 940.

In step 940, the method 900 includes calculating the cumulative perplexity for the first sentence plus the second sentence, and the difference in cumulative perplexity between the current and previous values. Execution then proceeds to step 950.

In step 950, the method 900 includes calculating the cumulative perplexity for the first sentence plus the second sentence plus the third sentence, and the difference in cumulative perplexity between the current and previous values. Execution then proceeds to step 960.

In step 960, the method 900 is complete.

Although the example of FIG. 9 shows a text with three sentences, it is understood that the machine-generated text may include any number of sentences, from one to several hundred, or more.

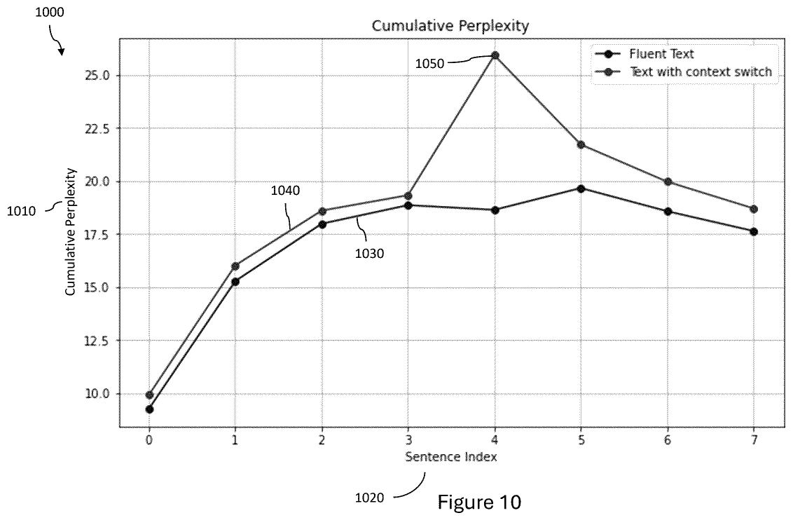

FIG. 10 is a graph 1000 showing cumulative perplexity 1010 as a function of sentence number or sentence index 1020, in accordance with at least one embodiment of the present disclosure. The graph 1000 shows a first line 1030 representing fluent text, where the cumulative perplexity 1010 increases from approximately 10 for the first sentence (e.g., sentence #0) to approximately 19 for the fourth sentence (e.g., sentence #3), and remains between 17.5 and 20 thereafter, through the eighth sentence (e.g., sentence #7), with no sudden changes in value. The graph 1000 also shows a second line 1040 representing text with an abrupt context shift. Like the first line 1030, the second line 1040 rises from about 10 to about 19 over the course of the first four sentences. However, unlike the first line 1030, the second line 1040 shows an abrupt change in cumulative perplexity 1010 between the fourth sentence (e.g. sentence #3) and the fifth sentence (e.g., sentence #4), from a value of approximately 19 to a value of approximately 26, and then an abrupt reduction to values similar to those seen for the first line 1030. This spike 1050 may be indicative of a change in context or tone between the fourth sentence (e.g., sentence #3) and the fifth sentence (e.g., sentence #4).

The use of cumulative perplexity in financial crime detection is particularly beneficial in the generation of reports, summaries, and alerts that need to maintain thematic consistency over time. Financial crime reports often involve complex data from transactions, legal contexts, and financial histories, all of which must be integrated into a coherent narrative. Cumulative perplexity ensures that AI-generated content remains focused on the task at hand, reducing the risk of introducing irrelevant or inconsistent information that could mislead investigators.

In the context of AML or fraud detection, cumulative perplexity can continuously monitor the generated text to ensure it adheres to the relevant financial themes, flags any inconsistencies, and allows for quick correction. This method improves the quality of AI-generated content, ensuring that the resulting reports are both accurate and coherent, which is crucial for decision-making in these high-risk areas.

The introduction of cumulative perplexity represents a significant advancement in the evaluation of AI-generated narratives. Unlike traditional perplexity metrics, which provide a static, retrospective evaluation of text, cumulative perplexity offers a dynamic, real-time analysis that allows for the detection and correction of inconsistencies as they arise. By incorporating both incremental perplexity measurements and smoothness analysis (e.g., changes in cumulative perplexity), the present disclosure offers a comprehensive solution to the problem of narrative incoherence in AI-generated content, with particular relevance to the field of financial crime detection.

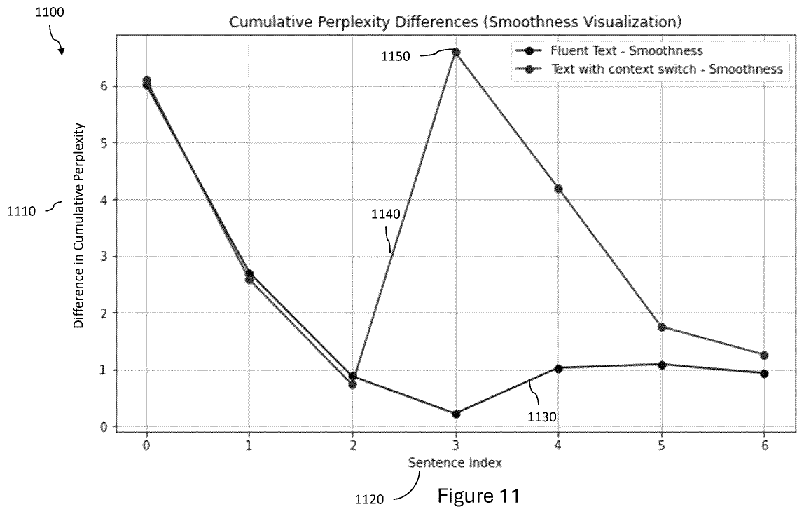

FIG. 11 is a graph 1100 showing cumulative perplexity difference 1110 as a function of sentence number or sentence index 1120, in accordance with at least one embodiment of the present disclosure. For both a fluent text 1130 and a text with a context switch 1140, the cumulative perplexity difference 1110 starts out at a high value of 6, indicating the difficulty of predicting a first sentence without prior context. However, in both cases, the cumulative perplexity difference then drops to around 1. In the case of fluent text 1130, the cumulative perplexity difference 1110 then remains around 1 through the end of the text (sentence #6). However, in the case of the non-fluent text 1140, the cumulative perplexity difference shows a spike 1150 to a value of around 7 at sentence #3, before gradually declining back to a value of around 1.3 at sentence #6. This spike 1150 provides a clear visual indicator that there may be a problem with the text around sentence #3.

Smoothness Analysis: A Novel Approach to Coherence. In addition to detecting shifts in topic or tone, the present disclosure introduces the concept of Smoothness Analysis. This involves tracking the variation in cumulative perplexity over time to assess the overall evenness of the narrative flow. A steady, gradual change in perplexity suggests a smooth, coherent progression of the narrative, while sudden jumps in perplexity indicate disruptions that need attention.

The system calculates the difference in cumulative perplexity between consecutive sentences as:

Perplexity Difference_{i,i+1}=|Cumulative Perplecityᵢ−Cumulative Perplexityᵢ₊₁ (EQN. 4)

If the difference exceeds a predefined threshold, it triggers a flag for potential disruptions in the text. This method allows for both local detection of inconsistencies and an overall global analysis of narrative smoothness.

Fluent Text: In a fluent, coherent report, the differences in cumulative perplexity between consecutive sentences are small and gradual. The graph may therefore show a smooth, relatively flat line, indicating that the AI model is maintaining consistency and predictability from one sentence to the next, ensuring that the narrative flows seamlessly.

Disrupted Text: For reports with narrative disruptions, the cumulative perplexity differences will show more pronounced jumps between consecutive sentences. These spikes represent points where the model's predictions are significantly affected by shifts in topic, tone, or content. For instance, if the model moves from discussing financial transactions to an unrelated topic, such as medical terminology, the graph will show a sharp spike in perplexity, signaling a disruption in the text's flow.

One of the main advantages of FIG. 11 is that it demonstrates the sensitivity of the system to incremental shifts in narrative flow. While FIG. 10 showed the overall trends in perplexity, FIG. 11 focuses on sentence-level changes, allowing for an even more detailed level of detection. FIG. 11 emphasizes the real-time detection of subtle disruptions. The ability to track cumulative perplexity differences between consecutive sentences allows the system to catch small, incremental inconsistencies as soon as they occur. This feature is particularly important in high-stakes domains such as financial crime detection, where even minor deviations from the intended narrative can have significant consequences.

FIG. 11 also provides actionable feedback for prompt engineers and analysts, whether human or automated. By tracking the cumulative perplexity differences at the sentence level, the system highlights exactly where the model's output deviates from the intended narrative flow. This allows for targeted interventions, such as refining the input prompt or guiding the model to focus on the relevant data.

For example, if the model generates a sentence that starts to deviate by introducing unrelated content, the feedback from FIG. 11 will help the engineer identify the issue and refine the prompt to steer the model back on track. This fine-grained feedback mechanism significantly enhances the quality of the generated text, ensuring that the final report is both coherent and aligned with the investigative objectives.

In summary, FIG. 11 may play a crucial role in demonstrating how cumulative perplexity provides a more detailed, sentence-level analysis of AI-generated content. By comparing the cumulative perplexity differences between consecutive sentences, it offers real-time insights into the fine-grained shifts in narrative flow that might otherwise go unnoticed. This enables the detection of subtle disruptions as soon as they occur, ensuring that the AI-generated report remains focused, relevant, and coherent.

Moreover, the real-time monitoring and feedback mechanisms embedded in the system allow for rapid intervention during text generation, ensuring that inconsistencies are addressed before they affect the overall quality of the report. The ability to pinpoint exact sections that need revision, combined with the sensitivity of cumulative perplexity to narrative disruptions, significantly enhances the reliability of AI-generated content, making it more actionable for investigators and compliance officers.

The threshold-based flagging system allows users to tailor the sensitivity of the cumulative perplexity method to their specific needs, ensuring that it can be applied effectively across various types of reports and domains.

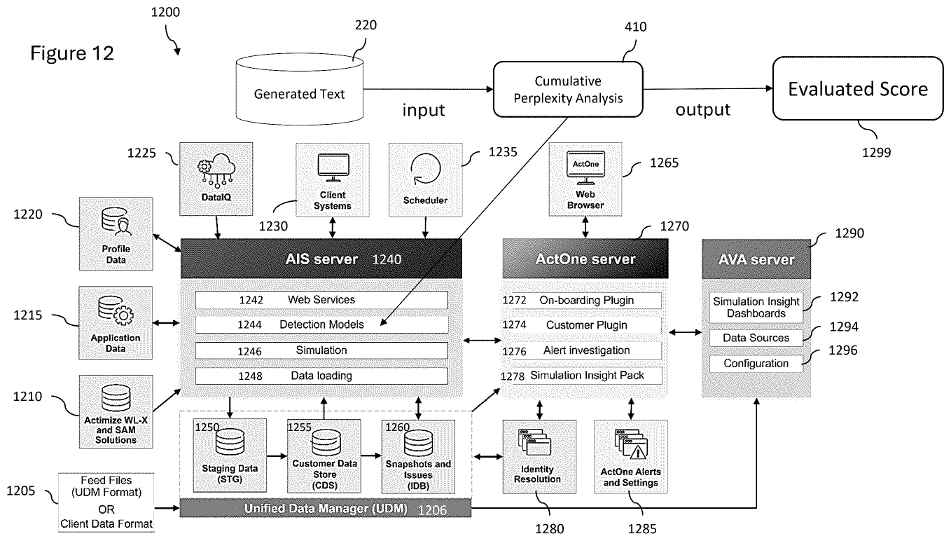

FIG. 12 is a schematic, diagrammatic representation, in block diagram form, of a fraud management system 1200 that includes the cumulative perplexity measurement system, in accordance with at least one embodiment of the present disclosure. In the example shown in FIG. 12, the fraud management system 1200 includes an analytics intelligence server (AIS) 1240, a policy manager server 1270, an Actimize visual analytics (AVA) server 1290 (which may for example combine fast analytics, visualization, and business intelligence, without the need for programming) and a unified data manager (UDM) 1206.

The UDM 1206 receives data from feed files 1205, and includes a staging data store 1250, a customer data store 1255, and a snapshots and issues database 1260.

The AIS server 1240 communicates with a watchlist and suspicious activity monitoring database 1210, application data 1215, profile data 1220, DataIQ solution 1225 (which may for example aggregate critical data from a wide variety of data sources and return the intelligence needed to enrich client profiles within the application), client systems 1230, and a scheduler 1235. The AIS server includes web services 1242, detection models 1244, simulation 1246, and data loading 1248. The AIS server 1240 communicates with the UDM 1206 and the policy manager server 1270. The detection models 1244 of the AIS server 1240 include the cumulative perplexity analysis 410 on the generated text 220, yielding a cumulative perplexity score 1299. The cumulative perplexity analysis 410 may be synchronized with a application program interface (API) of the LLM.

The policy manager server 1270 receives data from a web browser 1265, identity resolution module 1280, alerts and settings module 1285, and the UDM 1206. The policy manager server 1270 includes an on-boarding plugin 1272, customer plugin 1274, alert investigation module 1276, and a simulation insight pack 1278.

The AVA server 1290 communicates with the policy manager server 1270, receives data from the unified data manager 1206, and includes simulation insight dashboards 1292, data sources 1294, and a configuration module 1296.

The software architecture shown in FIG. 12 is exemplary rather than limiting. It is understood that the cumulative perplexity measurement system may be included into myriad different software architectures while still performing the same or similar functions to those described herein.

FIG. 13 is a screen display 1300 of a dashboard visualization for an example cumulative perplexity measurement system, in accordance with at least one embodiment of the present disclosure. The screen display 1300 facilitates the monitoring of cumulative perplexity trends in real-time. This step can play a crucial role in the practical application of the cumulative perplexity method, providing users with a visual tool for quickly assessing the quality of AI-generated content. The dashboard is a part of the system that integrates the real-time evaluation of the generated text and makes it easier for prompt engineers or analysts, whether human or automated, to identify problematic sections that need attention.

The screen display 1300 includes a threshold adjustment tool 1310, a cumulative perplexity difference graph 1320, and a text display window 1330. The text display window 1330 displays a paragraph of fluent text 1340, followed by a bold-faced sentence 1360 that includes a sudden topic switch, followed by several sentences 1350 that follow the new topic. The cumulative perplexity difference graph 1320 includes a peak 1365 at the fourth sentence (e.g., sentence #3), which is where the sudden change of topic occurs.

The screen display 1300 can serve as a user interface that allows users to visually monitor the cumulative perplexity scores over time, track disruptions in the text, and make informed decisions about necessary interventions. This may be particularly important in high-stakes domains like financial crime detection, where the accuracy and coherence of AI-generated content directly impact the ability to investigate and prevent illicit activities.

Cumulative perplexity Graphs: The dashboard displays real-time graphs of cumulative perplexity trends as the text is generated. These graphs visualize the evolving perplexity score over time, making it easier to spot fluctuations that indicate disruptions in narrative flow. For example, a steady increase or sudden spike in the graph could indicate a shift in topic, tone, or style, prompting further examination.

When a significant jump in cumulative perplexity is detected (i.e., when the difference between consecutive sentences exceeds a predefined threshold), the dashboard 1300 visually highlights these flagged sections 1360. This feature can help users quickly identify the points in the generated text where disruptions occur, making it easy to pinpoint exactly where the narrative has become inconsistent.

The dashboard 1300 may include an interactive feature 1310 that allows users to set the threshold for acceptable perplexity differences. This means users can fine-tune how sensitive the system is to narrative inconsistencies, adjusting the flagging mechanism based on the specific requirements of the task at hand. If the perplexity difference exceeds the threshold, the system triggers an alert, ensuring that the user is notified immediately, or that automated corrective measures are implemented.

In addition to graphical trends, the dashboard may include textual summaries of the flagged sections. For example, the specific sentences where perplexity shifts are detected may be listed, accompanied by a visual representation showing the sharp increase in perplexity. This dual approach-textual and graphical-helps users quickly assess the situation and take appropriate actions.

In some embodiments, the dashboard may also show the real-time adjustment feature, where the model can self-correct based on the feedback provided by the flagged perplexity spikes. For example, the AI system might be prompted to refine its output by refocusing on the key suspicious transactions, eliminating the irrelevant legal details.

The integration of an interactive dashboard with real-time cumulative perplexity tracking has several advantages in the context of financial crime detection:

Efficiency in Monitoring: Financial crime investigations often involve processing large volumes of data. The dashboard enables prompt engineers and investigators to monitor the quality of AI-generated content at scale. Instead of manually reviewing each report in detail, they can rely on the dashboard to highlight flagged disruptions that need attention, significantly speeding up the review process.

Customizable Sensitivity: The ability to adjust the threshold for perplexity differences allows users to tailor the sensitivity of the system according to the complexity of the data. For example, in a highly sensitive financial crime investigation, the user might set a lower threshold to detect even minor disruptions, while in less critical cases, a higher threshold may be acceptable.

Targeted Interventions: The dashboard provides users with actionable insights in real-time, enabling targeted interventions. Once a disruption is flagged, the system can suggest specific actions, such as revising the prompt to focus on the relevant financial data or adjusting the model's parameters to ensure coherence.

Transparency and Traceability: By providing both visual and textual representations of the generated text and its associated perplexity scores, the dashboard ensures transparency in the process. Investigators can trace back to the exact sentences or sections where disruptions occurred, helping them understand why the model generated incoherent content. This transparency may be particularly important in high-stakes environments like financial crime detection, where every decision must be carefully documented.

In some embodiments, the user interface can be used in a simple, intuitive workflow. As an example: the user begins generating a report or summary related to a financial crime investigation. The AI system outputs the text incrementally, with the dashboard continuously updating the cumulative perplexity graph. If any discrepancies in narrative flow (such as topic drift or tone shift) are detected, the difference in perplexity between consecutive sentences is highlighted. The user can then click on the flagged sections to view the sentences and make necessary adjustments, either by refining the model's focus or by prompting a manual revision. This process can help ensure that the quality of the AI-generated content is maintained throughout the entire generation process, leading to more reliable and actionable reports.

FIG. 13 illustrates the practical application of the cumulative perplexity measurement system through the interactive dashboard, which offers a visual and actionable way to monitor and correct narrative inconsistencies in real-time. By providing continuous feedback on the quality of AI-generated text, the dashboard helps ensure that generated reports and summaries remain focused, relevant, and consistent with the investigation's goals. This real-time intervention mechanism not only improves the accuracy of generated content but also enhances the efficiency of the financial crime detection process by enabling prompt engineers and investigators to act quickly on flagged disruptions.

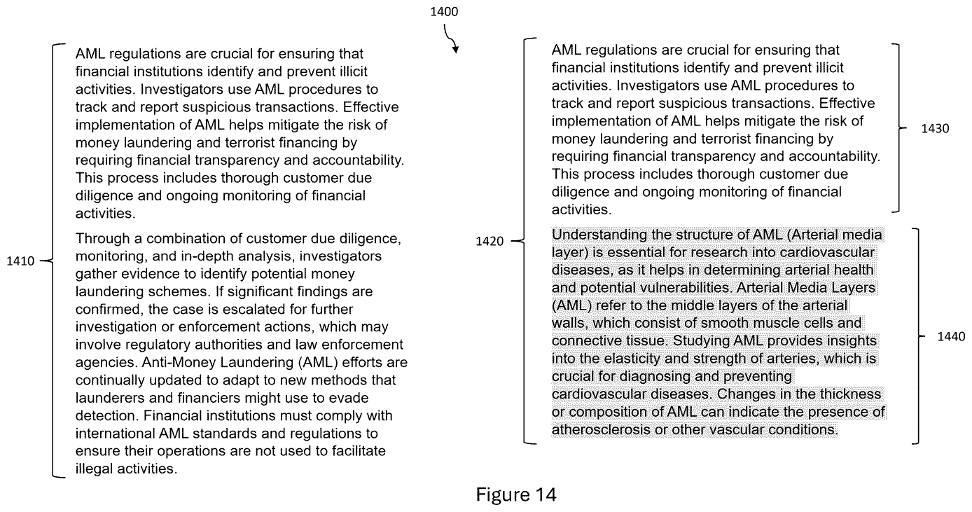

FIG. 14 shows a screen display 1400 comparing a fluent text 1410 and a non-fluent text 1420, in accordance with at least one embodiment of the present disclosure. The non-fluent text 1420 includes a fluent portion 1430 and a topic-shifted portion 1440. For clarity, the topic-shifted portion 1440 has been highlighted.

The present disclosure introduced in the previous sections leverages cumulative perplexity to enhance the real-time evaluation of AI-generated content, particularly in complex and specialized domains such as financial crime detection. This section evaluates the effectiveness of the proposed system by analyzing its ability to detect narrative inconsistencies and improve the quality of AI-generated reports. The results of applying the cumulative perplexity method to sample financial crime reports are presented, demonstrating its practical value in detecting disruptions such as topic drift, tone shifts, and style inconsistencies.

The cumulative perplexity method was evaluated by applying it to various AI-generated financial crime reports, including summaries of suspicious transactions, money laundering cases, and fraud investigations. These reports were generated by an AI model without the intervention of cumulative perplexity monitoring to establish a baseline. The following evaluation criteria were used:

Detection of Narrative Shifts: The primary evaluation criterion was the method's ability to identify significant shifts in narrative flow, including topic drift and tone inconsistencies. The AI-generated reports were reviewed for any abrupt changes in focus, such as the introduction of irrelevant information (e.g., medical terminology in a financial crime report) or a sudden shift in tone (e.g., from formal to casual).

Real-Time Monitoring: The ability to provide real-time feedback and corrections was assessed by applying cumulative perplexity to reports as they were generated. The effectiveness of this continuous monitoring in detecting and addressing disruptions during text generation was analyzed.

Accuracy of Flagged Sections: Each flagged disruption was manually reviewed to determine if it corresponded to a genuine inconsistency. This included evaluating whether the flagged sections represented a true narrative disruption that required intervention.

The results from applying cumulative perplexity to the financial crime reports showed significant improvements over traditional evaluation methods. The following findings were noted:

The cumulative perplexity method demonstrated a high level of sensitivity to disruptions in narrative consistency. For example, in one case 1420, the model generated a report on anti-money laundering (AML), but midway through, the topic shifted abruptly to unrelated medical terminology. Traditional perplexity metrics did not flag this disruption, as the overall text remained grammatically sound. However, the cumulative perplexity score spiked significantly at the point of topic drift, immediately flagging this inconsistency for further review.

In real-time testing, cumulative perplexity effectively identified discrepancies as they occurred during the generation process. As the report progressed, any sharp increases in perplexity between consecutive sentences triggered automatic flags, enabling prompt engineers to address issues before they propagated further in the text. This real-time feedback ensured that the narrative remained coherent, and relevant content stayed on topic.

The flagged sections, after manual review, were found to correspond closely with genuine disruptions in narrative flow. The system was able to pinpoint the exact points where the narrative became inconsistent, allowing for targeted revisions. In a few cases, the intervention involved adjusting the model's focus to ensure the content stayed relevant to the investigation's goals, such as refocusing on suspicious financial transactions rather than irrelevant legal details or unrelated medical terminology.

FIG. 14 visualizes the cumulative perplexity trends for two key scenarios: one for a fluent, coherent AI-generated report 1410 and one for a report 1420 with abrupt narrative disruptions. This figure demonstrates how the cumulative perplexity measurement system behaves under both ideal conditions and when inconsistencies arise during text generation.

The fluent text 1410 is a report generated by the AI that maintains a consistent narrative flow throughout. The cumulative perplexity graph for this report (not shown) includes a relatively smooth and steady line, indicating that the AI is able to predict the next word with high accuracy, maintaining coherence and relevance across the entire text.

In contrast, the disrupted text 1420 contains significant shifts in topic, tone, or content. As the report progresses, cumulative perplexity spikes at certain points where narrative disruptions occur. For example, a shift from discussing a financial transaction to introducing an unrelated topic, such as medical terminology, will result in an abrupt increase in cumulative perplexity, signaling a disruption in the narrative flow.

The graph 1320 of FIG. 13 visually highlights these differences by showing smooth, consistent cumulative perplexity difference for fluent text. The line remains relatively steady, indicating minimal fluctuations in predictability as the AI continues to generate coherent content. The graph 1320 also shows a sudden spike 1365 in cumulative perplexity difference for disrupted text: When the narrative shifts unexpectedly, the graph shows sharp increases in perplexity, indicating areas where the model's ability to predict the next word diminishes due to the disruption in context. The graph 1320 illustrates the method's sensitivity to even minor disruptions in the narrative flow. It helps to demonstrate that cumulative perplexity is not just about measuring overall fluency but also about pinpointing exact points where the text begins to lose coherence. The sudden spikes in perplexity clearly correspond to points of inconsistency in the generated report, whether due to topic drift, a sudden shift in tone, or the introduction of irrelevant information.

FIG. 15 is a schematic, diagrammatic representation, in block diagram form, of an example cumulative perplexity measurement system 1500, in accordance with at least one embodiment of the present disclosure. The cumulative perplexity measurement system 1500 includes a database 1510 that supplies data to a prompt generation service 1520, which generates a prompt 1530. The prompt generation service may be or include an artificial intelligence such as a deep learning model, neural network, or large language model, or may simply aggregate information gathered from the database 1510. The prompt 1530 may include both structured and unstructured information, and may for example include details about a suspicious transaction, as well as details about the sender and beneficiary of the transaction. In another example, the prompt 1530 may include details about an ongoing fraud investigation. The prompt 1530 is then passed to the summary service 180 (e.g., a large language model or LLM), which generates a natural language summary or report 1540 about the information contained in the prompt 1530. The summary or report may for example be or include a suspicious transaction report, a fraud investigation report, an insider trading investigation report, or an anti-money-laundering investigation report.

The summary or report 1540 is then passed to the summary evaluation service 190, which performs cumulative perplexity analysis on the text in the summary or report 1540. If the cumulative perplexity analysis indicates a non-fluent text, the summary evaluation service pinpoints the location of the incongruity, and passes this information back to the prompt generation service 1520. The prompt generation service 1520 may then revise the prompt 1530, and/or instruct the summary service 180 to correct the erroneous sentence(s).

The summary evaluation service 190 may, instead or in addition, display the summary or report 1540 on a dashboard display 1300, along with graphical representations of the cumulative perplexity and cumulative perplexity difference on a per-sentence basis.

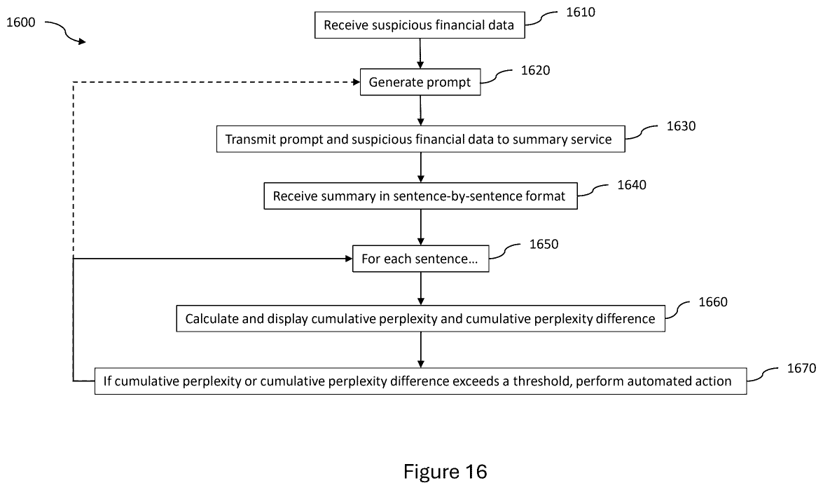

FIG. 16 is a schematic, diagrammatic representation, in flow diagram form, of an example cumulative perplexity measurement method 1600, in accordance with at least one embodiment of the present disclosure.

In step 1610, the method 1600 includes receiving suspicious financial data. The data may come from multiple sources, and may include both structured and unstructured data. The suspicious financial data may concern a person, entity, transaction, or pattern of transactions. The structured information may for example include financial documents, transaction reports, transaction records, transaction history, regulatory filings, regulatory updates, fraud patterns, investigative summaries, financial datasets, or customer profiles. Unstructured information may for example include customer communications, legal documents, regulatory guidelines, geopolitical risk factors, or descriptions of legal implications. Execution then proceeds to step 1620.

In step 1620, the method 1600 includes generating a prompt that includes or is based on the suspicious financial data, or includes instructions on how to interpret, summarize, or report on the suspicious financial data. Execution then proceeds to step 1630.

In step 1630, the method 1600 includes transmitting the prompt and the suspicious financial data to the summary service. Execution then proceeds to step 1650.

In step 1640, the method 1600 includes receiving a summary or report from the summary service in a real-time, sentence-by-sentence format.

In step 1650, the method includes initiating a loop, where steps 1660 and 1670 are applied for each incoming sentence received from the summary service.

In step 1660, the method 1600 includes calculating, and optionally displaying, the cumulative perplexity and cumulative perplexity difference for the cumulated text, up to and including the current sentence. Execution then proceeds to step 1670.

In step 1670, the method 1600 includes determining whether the cumulative perplexity or cumulative perplexity difference exceeds a threshold (e.g., a user-defined threshold, or a threshold that depends on the type on investigation). If yes, then perform an automated action, such as returning to step 1620 and revising the prompt. If no, then continue the loop by receiving the next sentence.

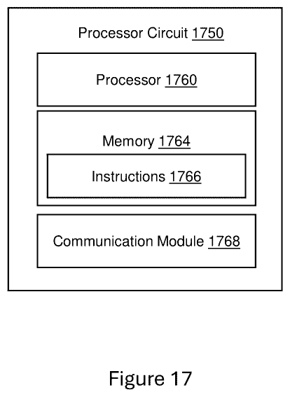

FIG. 17 is a schematic, diagrammatic representation of a processor circuit 1750, in accordance with at least one embodiment of the present disclosure. The processor circuit 1750 may be implemented in the system 100, 200, 300, 400, 500, 600, 1200 or 1500, or other devices or workstations (e.g., third-party workstations, network routers, etc.), or on a cloud processor or other remote processing unit, as necessary to implement the method. As shown, the processor circuit 1750 may include a processor 1760, a memory 1764, and a communication module 1768. These elements may be in direct or indirect communication with each other, for example via one or more buses.

The processor 1760 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 1760 may also comprise another hardware device, a firmware device, or any combination thereof configured to perform the operations described herein. The processor 1760 may also be implemented as a combination of computing devices, e.g., a combination of a DSP and a microprocessor, a plurality of microprocessors, one or more microprocessors in conjunction with a DSP core, or any other such configuration.

The memory 1764 may include a cache memory (e.g., a cache memory of the processor 1760), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 1764 includes a non-transitory computer-readable medium. The memory 1764 may store instructions 1766. The instructions 1766 may include instructions that, when executed by the processor 1760, cause the processor 1760 to perform the operations described herein. Instructions 1766 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 1768 can include any electronic circuitry and/or logic circuitry to facilitate direct or indirect communication of data between the processor circuit 1750, and other processors or devices. In that regard, the communication module 1768 can be an input/output (I/O) device. In some instances, the communication module 1768 facilitates direct or indirect communication between various elements of the processor circuit 1750 and/or the system 100, 200, 300, 400, 500, 600, 1200 or 1500. The communication module 1768 may communicate within the processor circuit 1750 through numerous methods or protocols. Serial communication protocols may include but are not limited to United States Serial Protocol Interface (US SPI), Inter-Integrated Circuit (I²C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, or receiving text from a cloud-based LLM, may be accomplished using any suitable wireless or wired communication technology, such as a cable interface such as a universal serial bus (USB), micro USB, Lightning, or FireWire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

As will be readily appreciated by those having ordinary skill in the art after becoming familiar with the teachings herein, the cumulative perplexity measurement system advantageously fills need in the art, by allowing users and automated systems to understand, in real-time, when and where a generated text has diverged from fluency, so that remedial actions (whether manual or automated) may be taken to re-focus the LLM and/or to correct the erroneous sentences.

A number of variations are possible on the examples and embodiments described above. For example, “large language model” refers to a particular architecture of text generation system, whereas the summary service may be some form of AI other than a large language model, that nevertheless is capable of generating a summary or report based on a prompt or other information. The technology described herein may be applied to areas other than financial crimes investigation, including but not limited to application on the LLMs themselves (e.g., by their vendors), or on any generative model that operates on text, or any other environment where the fluency of machine-generated text is important.

The logical operations making up the embodiments of the technology described herein are referred to variously as operations, steps, objects, elements, components, blocks, modules, etc. It should be understood that these may occur, or be performed or arranged, in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the cumulative perplexity measurement system. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/of” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the cumulative perplexity measurement system as defined in the claims. Although various embodiments of the claimed subject matter have been described above with a certain degree of particularity, or with reference to one or more individual embodiments, those of ordinary skill in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A real-time system for detecting and correcting inconsistencies in machine-generated text, the system comprising:
a fraud management server having at least one processor and a computer readable medium operably coupled thereto, the server being in electronic communication with a summary service, the server being configured to send suspicious financial data to the summary service and receive a summary of the suspicious financial data from the summary service, the processor comprising a summary evaluation service and a prompt generation service, the server being in electronic communication with a database for storing the suspicious financial data, the computer readable medium comprising a plurality of instructions stored in association therewith that are accessible to, and executable by, the processor, to perform operations which comprise:
receiving the suspicious financial data from the database;
with the prompt generation service, based on the suspicious financial data, generating a prompt;
transmitting the suspicious financial data and the prompt to the summary service;
in real time, receiving from the summary service a summary of the suspicious financial data, wherein the summary comprises natural language in a sentence-by-sentence format; and
with the summary evaluation service, for each sentence of the summary:
calculating a cumulative perplexity of the sentence and at least one previous sentence;
calculating a cumulative perplexity difference between the cumulative perplexity and a previous value of the cumulative perplexity; and
if the cumulative perplexity or the cumulative perplexity difference exceeds a threshold value, triggering an automated action.

2. The system of claim 1, wherein the automated action comprises, based on the suspicious financial data, the prompt, and the cumulative perplexity or the cumulative perplexity difference:
with the prompt generation service, revising the prompt; and
sending the revised prompt to the summary service.

3. The system of claim 1, wherein the automated action comprises instructing the summary service to:
correct the sentence or a previous sentence; and
continue generating the summary.

4. The system of claim 1, wherein calculating the cumulative perplexity of the sentence and at least one previous sentence involves calculating a cumulative perplexity of the sentence and all previous sentences.

5. The system of claim 1, wherein calculating the cumulative perplexity difference between the cumulative perplexity and a previous value of the cumulative perplexity involves calculating a cumulative perplexity difference between the cumulative perplexity and a most recent previous value of the cumulative perplexity.

6. The system of claim 1, wherein the operations further comprise:
displaying, to a user, a graph of the cumulative perplexity over time; and
updating the graph each time a new sentence is received.

7. The system of claim 1, wherein the operations further comprise:
displaying, to a user, a graph of the cumulative perplexity difference over time; and
updating the graph each time a new sentence is received.

8. The system of claim 1, wherein the suspicious financial data comprises structured information comprising at least one of: a financial document, a transaction report, a transaction record, a transaction history, a regulatory filing, a regulatory update, a fraud pattern, an investigative summary, a financial dataset, or a customer profile.

9. The system of claim 1, wherein the suspicious financial data comprises unstructured information comprising at least one of: a customer communication, a legal document, a regulatory guideline, a geopolitical risk factor, or a description of legal implications.

10. The system of claim 1, wherein the summary comprises a suspicious transaction report, a fraud investigation report, an insider trading investigation report, or an anti-money-laundering investigation report.

11. A computer-implemented method for detecting and correcting inconsistencies in real-time in machine-generated text, which method comprises:
with a fraud management server having at least one processor and a computer readable medium operably coupled thereto, the server being in electronic communication with a summary service, the server being configured to send suspicious financial data to the summary service and receive a summary of the suspicious financial data from the summary service, the processor comprising a summary evaluation service and a prompt generation service, the server being in electronic communication with a database for storing the suspicious financial data, performing operations which comprise:
receiving the suspicious financial data from the database;
with the prompt generation service, based on the suspicious financial data, generating a prompt;
transmitting the suspicious financial data and the prompt to the summary service;
in real time, receiving from the summary service a summary of the suspicious financial data, wherein the summary comprises natural language in a sentence-by-sentence format; and
with the summary evaluation service, for each sentence of the summary:
calculating a cumulative perplexity of the sentence and at least one previous sentence;
calculating a cumulative perplexity difference between the cumulative perplexity and a previous value of the cumulative perplexity; and
if the cumulative perplexity or the cumulative perplexity difference exceeds a threshold value, triggering an automated action.

12. The computer-implemented method of claim 11, wherein the automated action comprises, based on the suspicious financial data, the prompt, and the cumulative perplexity or the cumulative perplexity difference:
with the prompt generation service, revising the prompt; and
sending the revised prompt to the summary service.

13. The computer-implemented method of claim 11, wherein the automated action comprises instructing the summary service to:
correct the sentence or a previous sentence; and
continue generating the summary.

14. The computer-implemented method of claim 11, wherein calculating the cumulative perplexity of the sentence and at least one previous sentence involves calculating a cumulative perplexity of the sentence and all previous sentences.

15. The computer-implemented method of claim 11, wherein calculating the cumulative perplexity difference between the cumulative perplexity and a previous value of the cumulative perplexity involves calculating a cumulative perplexity difference between the cumulative perplexity and a most recent previous value of the cumulative perplexity.

16. The computer-implemented method of claim 11, wherein the operations further comprise:
displaying, to a user, a graph of the cumulative perplexity over time; and
updating the graph each time a new sentence is receives.

17. The computer-implemented method of claim 11, wherein the operations further comprise:
displaying, to a user, a graph of the cumulative perplexity difference over time; and
updating the graph each time a new sentence is received.

18. The computer-implemented method of claim 11, wherein the suspicious financial data comprises structured information comprising at least one of: a financial document, a transaction report, a transaction record, a transaction history, a regulatory filing, a regulatory update, a fraud pattern, an investigative summary, a financial dataset, or a customer profile.

19. The computer-implemented method of claim 11, wherein the suspicious financial data comprises unstructured information comprising at least one of: a customer communication, a legal document, a regulatory guideline, a geopolitical risk factor, or a description of legal implications.

20. The computer-implemented method of claim 11, wherein the summary comprises a suspicious transaction report, a fraud investigation report, an insider trading investigation report, or an anti-money-laundering investigation report.
